(19) United States
(12) Patent Application Publication
(10) Pub. No.: US 2004/0138350 A1
(43) Pub. Date: Jul. 15, 2004

(54) Stabilized metallocene polyolefins

(76) Inventors: Sylke Haremza, Neckargemund (DE); Manfred Appel, Landau (DE); Hubert Trauth, Dudenhofen (DE); Erik Hofmann, Hessheim (DE); Alban Glaser, Walldorf (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/476,500

(22) PCT Filed: May 10, 2002
(86) PCT No.: PCT/EP02/05150

(51) Int. Cl. C08K 5/34

(52) U.S. Cl. 524/91

(57) ABSTRACT

Stabilized thermoplastic molding compositions comprising

A) at least one polyolefin A) prepared using at least one metallocene catalyst, and

B) at least one stabilizer B) selected from the following groups b1) to b4)

b1) sterically hindered amines based on glycolurils,

b2) sterically hindered amines based on 4-formylaminopiperidines,

b3) sterically hindered amines based on maleimide-α-olefin copolymers, and

b4) sterically hindered amines selected from certain particular compounds.

The invention relates to stabilized thermoplastic molding compositions comprising

A) at least one polyolefin A) prepared using at least one metallocene catalyst, and

B) at least one stabilizer B) selected from the following groups b1) to b4)

b1) sterically hindered amines based on glycolurils,

b2) sterically hindered amines based on 4-formylaminopiperidines,

b3) sterically hindered amines based on maleimide-α-olefin copolymers,

b4) sterically hindered amines based on

bis(2,2,6,6-tetramethylpiperidin-4-yl) sebacate,

bis(2,2,6,6-tetramethylpiperidin-4-yl) succinate,

bis(1,2,2,6,6-pentamethylpiperidin-4-yl) sebacate,

bis(1-octyloxy-2,2,6,6-tetramethylpiperidin-4-yl) sebacate, bis(1,2,2,6,6-pentamethylpiperidin-4-yl)

n-butyl-3,5-di-tert-butyl-4-hydroxybenzylmalonate, the condensation product of

1-(2-hydroxyethyl)-2,2,6,6-tetramethyl-4-hydroxypiperidine and succinic acid, the condensation product of N,N′-bis(2,2,6,6-tetramethylpiperidin-4-yl)hexamethylenediamine and

4-tert-octylamino-2,6-dichloro-1,3,5-triazine,

tris(2,2,6,6-tetramethylpiperidin-4-yl) nitrilotriacetate,

tetrakis(2,2,6,6-tetramethylpiperidin-4-yl) butane 1,2,3,4-tetracarboxylate,

1,1′-(1,2-ethylene)bis(3,3,5,5-tetramethylpiperazinone),

4-benzoyl-2,2,6,6-tetramethylpiperidine,

4-stearyloxy-2,2,6,6-tetramethylpiperidine,

bis(1,2,2,6,6-pentamethylpiperidin-4-yl)

2-n-butyl-2-(2-hydroxy-3,5-di-tert-butylbenzyl)malonate,

3-n-octyl-7,7,9,9-tetramethyl-1,3,8-triazaspiro[4.5]decane-2,4-dione,

bis(1-octyloxy-2,2,6,6-tetramethylpiperidin-4-yl) sebacate,

bis(1-octyloxy-2,2,6,6-tetramethylpiperidin-4-yl) succinate, the condensation product of

N,N′-bis(2,2,6,6-tetramethylpiperidin-4-yl)hexamethylenediamine and

4-morpholino-2,6-dichloro-1,3,5-triazine, the condensation product of

2-chloro-4,6-bis(4-n-butylamino-2,2,6,6-tetramethylpiperidin-4-yl)-1,3,5-triazine and 1,2-bis(3-aminopropylamino)ethane, the condensation product of

2-chloro-4,6-di(4-n-butylamino-1,2,2,6,6-pentamethyl-piperidin-4-yl)-1,3,5-triazine and 1,2-bis-(3-amino-propylamino)ethane,

8-acetyl-3-dodecyl-7,7,9,9-tetramethyl-1,3,8-triazaspiro[4.5]decane-2,4-dione,

3-dodecyl-1-(2,2,6,6-tetramethylpiperidin-4-yl)pyrrolidine-2,5-dione,

3-dodecyl-1-(1,2,2,6,6-pentamethylpiperidin-4-yl)pyrrolidine-2,5-dione, a mixture of 4-hexadecyloxy-and 4-stearyloxy-2,2,6,6-tetramethylpiperidine, the condensation product of

N,N′-bis(2,2,6,6-tetramethylpiperidin-4-yl)hexamethylenediamine and 4-cyclohexylamino-2,6-dichloro-1,3,5-triazine, the condensation product of 1,2-bis(3-aminopropylamino)ethane and 2,4,6-trichloro-1,3,5-triazine,

4-butylamino-2,2,6,6-tetramethylpiperidine,

N-(2,2,6,6-tetramethylpiperidin-4-yl)-n-dodecylsuccinimide,

N-(1,2,2,6,6-pentamethylpiperidin-4-yl)-n-dodecylsuccinimide,

2-undecyl-7,7,9,9-tetramethyl-1-oxa-3,8-diaza-4-oxo-spiro[4.5]decane, the condensation product of

7,7,9,9-tetramethyl-2-cycloundecyl-1-oxa-3,8-diaza-4-oxospiro-[4.5]decane and epichlorohydrin, the condensation products of

4-amino-2,2,6,6-tetramethylpiperidine with tetramethylolacetylenediureas and poly(methoxypropyl-3-oxy)[4-(2,2,6,6-tetramethyl)piperidinyl]siloxane.

The invention further relates to the use of the molding compositions for producing moldings, films, or fibers, and also to moldings, films, and fibers made from the molding compositions mentioned. Finally, the invention relates to a process for preparing the molding compositions.

The use of sterically hindered amines as light stabilizers or antioxidants in polymers is known. They inhibit light-induced aging and degradation of the polymer, which is noticeable as yellowing, discoloration, cracking, or embrittlement, for example.

DE-A 100 03 866 proposes stabilizing polyolefins prepared using metallocene catalysts (known as metallocene polyolefins) by means of a stabilizer mixture which comprises certain substituted piperidines and certain substituted triazines, acting as sterically hindered amines. Some aspects of the property profile of these stabilized metallocene polyolefins are unsatisfactory.

It is an object of the present invention to eliminate this disadvantage and to provide stabilized metallocene polyolefins with an optimized property profile.

We have found that this object is achieved by means of the stabilized thermoplastic molding compositions defined at the outset. The invention also provides the use of the molding compositions for producing moldings, films, or fibers, and also moldings, films, and fibers made from the molding compositions mentioned, and a process for preparing the molding compositions.

The components of the molding composition are described in more detail below.

Component A)

As component A), the molding compositions comprise at least one polyolefin prepared using at least one metallocene catalyst. Polyolefins of this type are also termed metallocene polyolefins. Polyolefins suitable as component A) are any of those prepared with concomitant use of metallocene catalysts. The metallocene complexes described below are examples rather than a complete list.

Particular olefins which can be polymerized using a metallocene catalyst are ethylene and a-olefins, such as propylene, 1-butene, 4-methyl-1-pentene, 5-methyl-1-hexene; isohexene, isooctene; cycloolefins (e.g. cyclopentadiene (monomer or dimer) and norbornene); styrene, and mixtures of olefins, such as ethylene/propylene and propylene mixed with very small amounts of higher α-olefins. Preference is given here to the C₂ and C₃ olefins and copolymers of these.

For the purposes of the present invention, polymers are either homopolymers or copolymers made from a main monomer which is one of the monomers mentioned and from other monomers as comonomers.

Preferred polyolefins are the homopolymers and copolymers of ethylene, and also the homopolymers and copolymers of propylene. These are described in more detail below.

Ethylene Polymers:

An example of a commercially available polyethylene prepared using metallocene catalysts is Luflexen® (Basell). The metallocene catalyst system is described in more detail below.

Examples of suitable metallocene complexes are the following compounds of the formula:

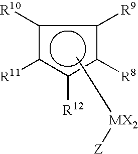

where:

M is titanium, zirconium, hafnium, vanadium, niobium or tantalum,

X is fluorine, chlorine, bromine, iodine, hydrogen or C₁-C₁₀-alkyl,

R⁸ to R¹² are hydrogen, C₁-C₁₀-alkyl, 5- to 7-membered cycloalkyl which in turn may have a C₁-C₁₀-alkyl substituent, or are C₆-C₁₅-aryl or arylalkyl, where, if desired, it is also possible for two adjacent radicals together to be a cyclic group having from 4 to 15 carbon atoms, or are Si(R¹³)₃, where

R¹³ is C₁-C₁₀-alkyl, C₃-C₁₀-cycloalkyl, or C₆-C₁₅-aryl,

Z is X or

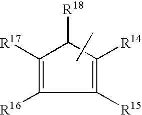

where

R¹⁴ to R¹⁸ are hydrogen, C₁-C₁₀-alkyl, 5- to 7-membered cycloalkyl, which may in turn have a C₁-C₁₀-alkyl substituent, or are C₆-C₁₅-aryl or arylalkyl, where, if desired, it is also possible for two adjacent radicals together to be a cyclic group having from 4 to 15 carbon atoms, or are Si(R¹⁹)₃, where

R¹⁹ is C₁-C₁₀-alkyl, C₆-C₁₅-aryl or C₃-C₁₀-cycloalkyl,

or where R¹¹ and Z together form a group —R²⁰-A-, where

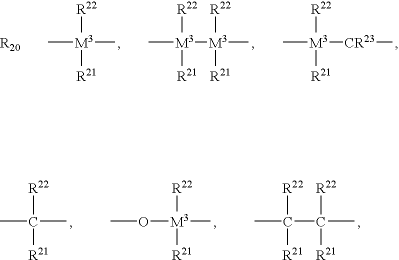

═BR²², ═AlR²², —Ge—, —Sn—, —O—, —S—, ═SO, ═SO₂, ═NR²², ═CO, ═PR²² or ═P(O)R²²

where R²¹, R²² and R²³ are identical or different and are hydrogen, halogen, C₁-C₁₀-alkyl, C₁-C₁₀-fluoroalkyl, C₆-C₁₀-fluoroaryl, C₆-C₁₀-aryl, C₁-C₁₀-alkoxy, C₂-C₁₀-alkenyl, C₇-C₄₀-arylalkyl, C₈-C₄₀-arylalkenyl, or C₇-C₄₀-alkylaryl, or where two adjacent radicals, in each case with the atoms to which they are linked, form a ring, and

M³ is silicon, germanium or tin,

A is

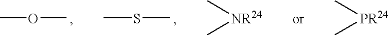

where,

R²⁴ is C₁-C₁₀-alkyl, C₆-C₁₅-aryl, C₃-C₁₀-cycloalkyl, alkylaryl or Si(R²⁵)₃,

R²⁵ is hydrogen, C₁-C₁₀-alkyl, C₆-C₁₅-aryl, which in turn may have C₁-C₄-alkyl as substituents, or C₃-C₁₀-cycloalkyl,

or where R¹¹ and R¹⁷ together form a group —R²⁰—.

Particularly suitable metallocene complexes may be found by way of example in DE-A 198 06 435, page 3, line 68 to page 5, line 67. This section of that text is expressly incorporated herein by way of reference.

These complex compounds may be synthesized by methods known per se, preferably by reacting the corresponding substituted cyclic hydrocarbon anions with halides of titanium, zirconium, hafnium, vanadium, niobium or tantalum. Examples of appropriate preparation processes may be found, inter alia, in the Journal of Organometallic Chemistry, 369 (1989), 359-370.

It is also possible to use mixtures of different metallocene complexes.

The metallocene complexes are generally activated by an activator compound. Particularly suitable activators are compounds which form metallocenium ions. Particularly suitable metallocenium-ion-forming compounds are complex compounds selected from the group consisting of strong, neutral Lewis acids, ionic compounds with Lewis acid cations and ionic compounds with Brönsted acids as cation.

Preferred strong, neutral Lewis acids are compounds of the formula

M⁴X¹X²X³

where

M⁴ is an element of the 3^{rd} main group of the Periodic Table, in particular B, Al or Ga,

X¹, X² and X³ are hydrogen, C₁-C₁₀-alkyl, C₆-C₁₅-aryl, alkylaryl, arylalkyl, haloalkyl or haloaryl, in each case having from 1 to 10 carbon atoms in the alkyl radical and from 6 to 20 carbon atoms in the aryl radical, or fluorine, chlorine, bromine or iodine, particularly haloaryl, preferably pentafluorophenyl.

Suitable ionic compounds with Lewis-acid cations are compounds of the formula

[(Y^{a}+)Q₁Q₂ . . . Q_{z}]^{d+}

where

Y is an element of the 1st to 6th main group, or of the 1st to 8th transition group, of the Periodic Table,

Q₁ to Q_{Z} are singly negatively charged radicals, such as C₁-C₂₈-alkyl, C₆-C₁₅-aryl, alkylaryl, arylalkyl, haloalkyl, haloaryl, in each case having from 6 to 20 carbon atoms in the aryl radical and from 1 to 28 carbon atoms in the alkyl radical, C₁-C₁₀-cycloalkyl, if desired having C₁-C₁₀-alkyl substituents, or are halogen, C₁-C₂₈-alkoxy, C₆-C₁₅-aryloxy, silyl or mercaptyl,

a is an integer from 1 to 6,

z is an integer from 0 to 5, and

d is the difference a-z, where d is greater than or equal to 1.

Carbonium cations, oxonium cations and sulfonium cations are particularly suitable, as are cationic transition metal complexes. Particular mention should be made of the triphenylmethyl cation, the silver cation and the 1,1′-dimethylferrocenyl cation. They preferably have non-coordinating counterions, in particular boron-compound ions, as also mentioned in WO-A 91/09882, preferably tetrakis(pentafluorophenyl)borate.

Ionic compounds having Brönsted acids as cations and preferably likewise non-coordinating counterions are mentioned in WO-A 91/09882, and a preferred cation is N,N-dimethylanilinium.

Suitable ethylene copolymers are any of the commercially available ethylene copolymers, such as Luflexen® grades (Basell), Nordel® (DuPont), Engage®, Affinity®, Elite® (Dow) and Finacene® (Atofina). Suitable comonomers are any of the α-olefins having from 3 to 10 carbon atoms, in particular propylene, 1-butene, 1-hexene and 1-octene, and also those alkyl acrylates and alkyl methacrylates which have from 1 to 20 carbon atoms in the alkyl radical, in particular butyl acrylate. Other suitable comonomers are dienes, e.g. butadiene, isoprene and octadiene, and also dicyclopentadiene.

The copolymers are usually random, block, or impact copolymers.

Block or impact copolymers made from ethylene with comonomers are polymers for which the first stage is to prepare a homopolymer of the comonomer, or a random copolymer of the comonomer with up to 15% by weight of ethylene, preferably up to 6% by weight of ethylene. In the second stage a comonomer-ethylene copolymer having an ethylene content of from 15 to 80% by weight is then polymerized onto the first polymer. The amount of the comonomer-ethylene copolymer polymerized onto the first polymer is generally such that the copolymer produced in the second stage makes up from 3 to 60% by weight of the final product.

The polymerization to prepare the ethylene-comonomer copolymers takes place using a metallocene catalyst system as described above.

In addition to polyethylene prepared using metallocene catalysts, the molding compositions of the invention may also comprise polyethylene prepared conventionally, or using catalyst systems based on metal complexes active in polymerization.

Examples of suitable conventional polyethylene (PE) homopolymers are:

LDPE (LD=low density), obtainable by the high-pressure process (ICI) at from 1000 to 3000 bar and from 150 to 300° C., with oxygen or peroxides as catalysts in autoclaves or tubular reactors. Highly branched with varying lengths of branching, crystallinity from 40 to 50%, density from 0.915 to 0.935 g/cm³, average molar mass up to 600 000 g/mol.

LLDPE (LLD=linear low density), obtainable using metal complex catalysts in the low-pressure process from the gas phase, or from a solution (e.g. petroleum spirit), or in a suspension, or using a modified high-pressure process. Low level of branching, with side chains themselves unbranched, molar masses higher than for LDPE.

HDPE (HD=high density), obtainable by the medium-pressure (Phillips) or low-pressure (Ziegler) process. In the Phillips process at from 30 to 40 bar, from 85 to 180° C., chromium oxide as catalyst, molar mass is about 50,000 g/mol. In the Ziegler process at from 1 to 50 bar, from 20 to 150° C., titanium halides, titanic esters, or aluminum alkyl compounds 40 as catalyst, molar mass from about 200 000 to 400 000 g/mol. Carried out in suspension, solution, gas phase, or bulk. Very low level of branching, crystallinity from 60 to 80%, density from 0.942 to 0.965 g/cm³.

HMWHDPE (HMW=high molecular weight), obtainable by the Ziegler, Phillips, or gas-phase method. High density and high molar mass.

UHMWHDPE (UHMW=ultra high molecular weight), obtainable using modified Ziegler catalyst, molar mass from 3 000 000 to 6 000 000 g/mol.

A particularly suitable material is a polyethylene such as Lupolen® (Basell) prepared by a gas-phase fluidized-bed process, using (usually supported) catalysts.

Propylene Polymers:

Polypropylene hereinafter means either homo- or copolymers of propylene. Copolymers of propylene contain subordinate amounts of monomers copolymerizable with propylene, such as C₂-C₈ 1-alkenes, e.g. ethylene, 1-butene, 1-pentene, or 1-hexene. It is also possible to use two or more different comonomers.

Examples of suitable polypropylenes are homopolymers of propylene or copolymers of propylene with up to 50% by weight of other copolymerized 1-alkenes having up to 8 carbon atoms. These copolymers of propylene are random copolymers or block or impact copolymers. If the copolymers of propylene have a random structure they generally contain up to 15% by weight, preferably up to 6% by weight, of other 1-alkenes having up to 8 carbon atoms, in particular ethylene, 1-butene, or a mixture of ethylene and 1-butene.

Block or impact copolymers of propylene are polymers for which the first stage is to prepare a propylene homopolymer or a random copolymer of propylene with up to 15% by weight, preferably up to 6% by weight, of other 1-alkenes having up to 8 carbon atoms, and the second stage is then to polymerize onto this a propylene-ethylene copolymer with ethylene contents of from 15 to 80% by weight, where the propylene-ethylene copolymer may also contain other C₄-C₈ 1-alkenes. The amount of the propylene-ethylene copolymer polymerized on is generally such that the copolymer produced in the second stage makes up a proportion of from 3 to 60% by weight of the final product.

The polypropylenes are prepared using metallocene catalysts.

For the purposes of the present invention, metallocenes are complexes made from metals of transition groups of the Periodic Table with organic ligands, these giving effective catalyst systems when combined with metallocenium-ion-forming compounds. The metallocene complexes are generally in supported form in the catalyst system when used for preparing polypropylene. The supports used are frequently inorganic oxides, but it is also possible to use organic supports in the form of polymers, for example polyolefins. Preference is given to the inorganic oxides described above, which may also be used for preparing the titanium-containing solid component a).

The central atom present in the metallocenes usually used is titanium, zirconium, or hafnium, preferably zirconium. The central atom generally has π bonding to at least one, generally substituted, cyclopentadienyl group, and also to other substituents. The other substituents may be halogens, hydrogen, or organic radicals, preferably fluorine, chlorine, bromine, or iodine, or C₁-C₁₀-alkyl.

The cyclopentadienyl group may also be a constituent of an appropriate heteroaromatic system.

Preferred metallocenes contain central atoms which have bonding to two substituted cyclopentadienyl groups via two n bonds of identical or different type, and particular preference is given to those in which substituents of the cyclopentadienyl groups have bonding to both cyclopentadienyl groups. Particular preference is given to complexes whose substituted or unsubstituted cyclopentadienyl groups also have substitution on two adjacent carbon atoms by cyclic groups, optionally with integration of the cyclic groups within a heteroaromatic system.

Preference is also given to metallocenes which contain only one substituted or unsubstituted cyclopentadienyl group which, however, has substitution by at least one radical which also has bonding to the central atom.

Examples of suitable metallocene compounds are

ethylenebis(indenyl)zirconium dichloride,

ethylenebis(tetrahydroindenyl)zirconium dichloride,

diphenylmethylene-9-fluorenylcyclopentadienylzirconium dichloride,

dimethylsilanediylbis(3-tert-butyl-5-methylcyclopentadienyl)-zirconium dichloride,

dimethylsilanediyl(2-methyl-4-azapentalene)(2-methyl-4(4′-methyl-phenyl)indenyl)zirconium dichloride,

dimethylsilanediyl(2-methyl-4-thiapentalene)(2-ethyl-4(4′-tert-butylphenyl)indenyl)zirconium dichloride,

ethanediyl(2-ethyl-4-azapentalene)(2-ethyl-4(4′-tert-butyl-phenyl)indenyl)zirconium dichloride,

dimethylsilanediylbis(2-methyl-4-azapentalene)zirconium dichloride,

dimethylsilanediylbis(2-methyl-4-thiapentalene)zirconium dichloride,

dimethylsilanediylbis(2-methylindenyl)zirconium dichloride,

dimethylsilanediylbis(2-methylbenzindenyl)zirconium dichloride,

dimethylsilanediylbis(2-methyl-4-phenylindenyl)zirconium dichloride,

dimethylsilanediylbis(2-methyl-4-naphthylindenyl)zirconium dichloride,

dimethylsilanediylbis(2-methyl-4-isopropylindenyl)zirconium dichloride, and

dimethylsilanediylbis(2-methyl-4,6-diisopropylindenyl)zirconium dichloride, and also the corresponding dimethylzirconium compounds.

The metallocene compounds are either known or can be obtained by methods known per se. Mixtures of metallocene compounds of this type may also be used for the catalysis, as can the metallocene complexes described in EP-A 416 815.

The metallocene catalyst systems also comprise metallocenium-ion-forming compounds. Suitable compounds are strong, neutral Lewis acids, ionic compounds having Lewis-acid cations, and ionic compounds having Brönsted acids as cation. Examples of these are tris(pentafluorophenyl)borane, tetrakis(pentafluorophenyl)borate, or salts of N,N-dimethylanilinium. Other suitable metallocenium-ion-forming compounds are open-chain or cyclic aluminoxane compounds. These are usually prepared by reacting trialkylaluminum compounds with water, and are generally mixtures of linear and cyclic chain molecules of various lengths.

The metallocene catalyst systems may moreover comprise organometallic compounds of metals of the 1^{st}, 2^{nd}, or 3^{rd} main group of the Periodic Table of the Elements, for example n-butyllithium, n-butyl-n-octylmagnesium, or triisobutylaluminum, triethylaluminum or trimethylaluminum.

In addition to polypropylene prepared using metallocene catalysts, the molding compositions of the invention may also comprise polypropylene prepared by a conventional route, or using catalyst systems based on metal complexes active in polymerization.

The polymerization for the conventional preparation of polypropylene may take place using a Ziegler-Natta catalyst system. The catalyst systems used here are in particular those which have, alongside a titanium-containing solid component a), cocatalysts in the form of organic aluminum compounds b) and electron-donor compounds c).

Specifically, conventional Ziegler-Natta catalyst systems comprise a titanium-containing solid component a), inter alia halides or alcohols of tri- or tetravalent titanium, and also a halogen-containing magnesium compound, inorganic oxides, e.g. silica gel, as support, and also electron-donor compounds c). Particular compounds which may be used in this context are carboxylic acid derivatives, and also ketones, ethers, alcohols or organosilicon compounds.

The titanium-containing solid component may be prepared by methods known per se. Examples of these are given, inter alia, in EP-A 45 975, EP-A 45 977, EP-A 86 473, EP-A 171 200, GB-A 2 111 066, U.S. Pat. No. 4,857,613 and U.S. Pat. No. 5, 288,824. Preference is given to the. use of the process known from DE-A 195 29 240.

Suitable aluminum compounds b) besides trialkylaluminum are compounds in which an alkyl group has been replaced by an alkoxy group or by a halogen atom, for example, by chlorine or bromine. The alkyl groups may be identical or different. Linear or branched alkyl groups may be used. Preference is given to the use of trialkylaluminum compounds each of whose alkyl groups has from 1 to 8 carbon atoms, for example trimethylaluminum, triethylaluminum, triisobutylaluminum, trioctylaluminum, or methyldiethylaluminum, or a mixture of these.

Use is generally made of electron-donor compounds c) as another cocatalyst alongside the aluminum compound b), examples of c) being mono- or polyfunctional carboxylic acids, carboxylic anhydrides, carboxylic esters, ketones, ethers, alcohols, lactones, and also organophosphorus and organosilicon compounds, and these electron-donor compounds c) may be identical with or different from the electron-donor compounds used to prepare the titanium-containing solid components a).

The preparation of the polypropylenes is carried out by polymerizing in at least one, or else frequently in two or even more, reaction zones arranged in sequence (reactor cascade), in the gas phase, in a suspension, or in the liquid phase (bulk phase). The reactors used may be those usual for polymerizing C₂-C₈ 1-alkenes. Examples of suitable reactors are continuous stirred tank reactors, loop reactors, and fluidized-bed reactors. The size of the reactors is not significant here, and it depends on the output to be achieved in each of the reaction zones.

The reactors used are particularly fluidized-bed reactors and horizontally or vertically agitated powder-bed reactors. The reaction bed is generally composed of the polymer being polymerized in the respective reactor from C₂-C₈ 1-alkenes.

The polymerization to prepare the polypropylenes used is carried out under conventional reaction conditions at from 40 to 120° C., in particular from 50 to 100° C., and at pressures of from 10 to 100 bar, in particular from 20 to 50 bar.

Suitable polypropylenes generally have a melt flow rate (MFR) to ISO 1133, of from 0.1 to 200 g/10 min, in particular from 0.2 to 100 g/10 min, at 230° C. under a load of 2.16 kg.

Component B)

The molding compositions comprise, as component B), at least one stabilizer selected from the following groups b1) to b4):

b1) sterically hindered amines based on glycolurils,

b2) sterically hindered amines based on 4-formylaminopiperidines,

b3) sterically hindered amines based on maleimide-α-olefin copolymers,

b4) sterically hindered amines based on

bis(2,2,6,6-tetramethylpiperidin-4-yl) sebacate,

bis(2,2,6,6-tetramethylpiperidin-4-yl) succinate,

bis(1,2,2,6,6-pentamethylpiperidin-4-yl) sebacate,

bis(1-octyloxy-2,2,6,6-tetramethylpiperidin-4-yl) sebacate,

bis(1,2,2,6,6-pentamethylpiperidin-4-yl)

n-butyl-3,5-di-tert-butyl-4-hydroxybenzylmalonate, the condensation product of

1-(2-hydroxyethyl)-2,2,6,6-tetramethyl-4-hydroxypiperidine and succinic acid, the condensation product of

N,N′-bis(2,2,6,6-tetramethylpiperidin-4-yl)hexamethylene-diamine and 4-tert-octylamino-2,6-dichloro-1,3,5-triazine,

tris(2,2,6,6-tetramethylpiperidin-4-yl) nitrilotriacetate,

tetrakis(2,2,6,6-tetramethylpiperidin-4-yl) butane 1,2,3,4-tetracarboxylate,

1,1′-(1,2-ethylene)bis(3,3,5,5-tetramethylpiperazinone),

4-benzoyl-2,2,6,6-tetramethylpiperidine,

4-stearyloxy-2,2,6,6-tetramethylpiperidine,

bis(1,2,2,6,6-pentamethylpiperidin-4-yl)

2-n-butyl-2-(2-hydroxy-3,5-di-tert-butylbenzyl)malonate,

3-n-octyl-7,7,9,9-tetramethyl-1,3,8-triazaspiro[4.5]decane-2,4-dione, bis(1-octyloxy-2,2,6,6-tetramethylpiperidin-4-yl) sebacate, bis(1-octyloxy-2,2,6,6-tetramethylpiperidin-4-yl) succinate, the condensation product of

N,N′-bis(2,2,6,6-tetramethylpiperidin-4-yl)hexamethylene-diamine and 4-morpholino-2,6-dichloro-1,3,5-triazine, the condensation product of

2-chloro-4,6-bis(4-n-butylamino-2,2,6,6-tetramethylpiperidin-4-yl)-1,3,5-triazine and 1,2-bis(3-aminopropylamino)ethane, the condensation product of

2-chloro-4,6-di(4-n-butylamino-1,2,2,6,6-pentamethyl-piperidin-4-yl)-1,3,5-triazine and 1,2-bis-(3-amino-propylamino)ethane,

8-acetyl-3-dodecyl-7,7,9,9-tetramethyl-1,3,8-triazaspiro-[4.5]decane-2,4-dione,

3-dodecyl-1-(2,2,6,6-tetramethylpiperidin-4-yl)pyrrolidine-2,5-dione,

3-dodecyl-1-(1,2,2,6,6-pentamethylpiperidin-4-yl)pyrrolidine-2,5-dione, a mixture of 4-hexadecyloxy- and 4-stearyloxy-2,2,6,6-tetramethylpiperidine, the condensation product of

N,N′-bis(2,2,6,6-tetramethylpiperidin-4-yl)hexamethylene-diamine and 4-cyclohexylamino-2,6-dichloro-1,3,5-triazine,

the condensation product of 1,2-bis(3-aminopropylamino)ethane and 2,4,6-trichloro-1,3,5-triazine,

4-butylamino-2,2,6,6-tetramethylpiperidine,

N-(2,2,6,6-tetramethylpiperidin-4-yl)-n-dodecylsuccinimide,

N-(1,2,2,6,6-pentamethylpiperidin-4-yl)-n-dodecylsuccinimide,

2-undecyl-7,7,9,9-tetramethyl-1-oxa-3,8-diaza-4-oxospiro[4.5]decane, the condensation product of

7,7,9,9-tetramethyl-2-cycloundecyl-1-oxa-3,8-diaza-4-oxospiro [4.5]decane and epichlorohydrin, the condensation products of 4-amino-2,2,6,6-tetramethylpiperidine with tetramethylolacetylenediureas and poly(methoxypropyl-3-oxy)[4-(2,2,6,6-tetramethyl)piperidinyl]siloxane.

The amines b4) are particular compounds, and there is therefore no need for any further information. These particular compounds are known and available commercially.

The following may be said concerning the amines of groups b1) to b3).

b1) Amines Based on Glycolurils (Group b1))

The amines used and based on glycolurils are preferably compounds of the formula (I)

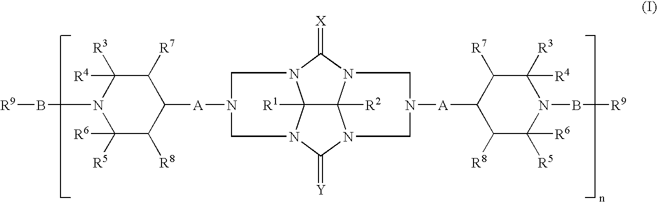

where:

n is a number from 1 to 70,

R¹ and R², independently of one another, are hydrogen, C₁-C₆-alkyl, C₇-C₁₂-aralkyl, aryl, or a carboxylic ester group, or R¹ and R² together are a tetra-, penta- or hexamethylene group or an unsubstituted or substituted radical of the formula

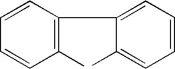

R³, R⁴, R⁵ and R⁶, independently of one another, are alkyl,

R⁷ and R⁸, independently of one another, are hydrogen or alkyl, or together with the associated carbon atom form a

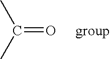

X and Y, independently of one another, are oxygen, sulfur, or NR¹⁰, where R¹⁰ is hydrogen, C₁-C₈-alkyl, or C₇-C₁₂-aralkyl,

R⁹ is hydrogen, C₁-C₂₂-alkyl, which may be hydroxyl-, carbonyl-, carboxylic-ester-, carboxy-, carbamoyl-, sulfonyl-, sulfinyl-, or thiol-substituted, C₃-C₂₂-alkenyl, C₃-C₂₂-alkynyl, C₇-C₁₂-aralkyl, C₁-C₂₂-alkyl, C₄-C₂₂-cycloalkylalkyl, an unsubstituted or substituted heterocycle, chlorine, bromine, iodine, hydroxyl, alkoxy, carboxy, carboxylic ester, sulfonamido, unsubstituted or substituted carbamoyl, a urea group, or a urethane group, or

—(—CH₂—)ₖ-D

where k is a number from 1 to 10 and D is —CN, —NH₂, —NHR¹¹ or —NR¹¹R¹², where R¹¹ and R¹² are identical or different and are C₁-C₂₂-alkyl, C-acyl, carbamoyl, sulfonyl, sulfinyl, C₂-C₂₂-alkenyl, C₃-C₂₂-alkynyl, C₃-C₁₂-cycloalkyl, aralkyl, or oligomeric or polymeric polyamine, and the radicals may also have further substitution, or where R¹¹ and R¹² together with the nitrogen atom to which they are bonded form a 3- to 20-membered ring system,

A are identical or different and are a direct bond or a bridging unit, with the proviso that at least one A is a bridging unit if R⁹ is not —(—CH₂—)ₖ-D, and

B is another bridging unit or a direct bond, or the acid-adduct salts or hydrates of the compounds of the formula I.

Examples of particular radicals R¹ and R², besides hydrogen, are: methyl, ethyl, propyl, butyl, pentyl, hexyl, benzyl, phenylethyl, phenylpropyl, phenylbutyl, methylbenzyl, phenyl, tolyl, carbomethoxy, carboethoxy, carbopropoxy, and carbobutoxy.

For R¹ and R² preference is given to ethyl, benzyl, carbomethoxy, carboethoxy, and in particular hydrogen, methyl, or phenyl.

R⁹ is preferably hydrogen, C₁-C₂₂-alkyl, in particular C₁-C₄-alkyl, preferably methyl, which may have substitution by a hydroxyl or carboxy group, or is C₃-C₈-alkenyl, in particular allyl, C₇-C₁₂-aralkyl, in particular benzyl, —CH₂—CN, or —(CH₂)₂—CN; other examples of R⁹ are the following:

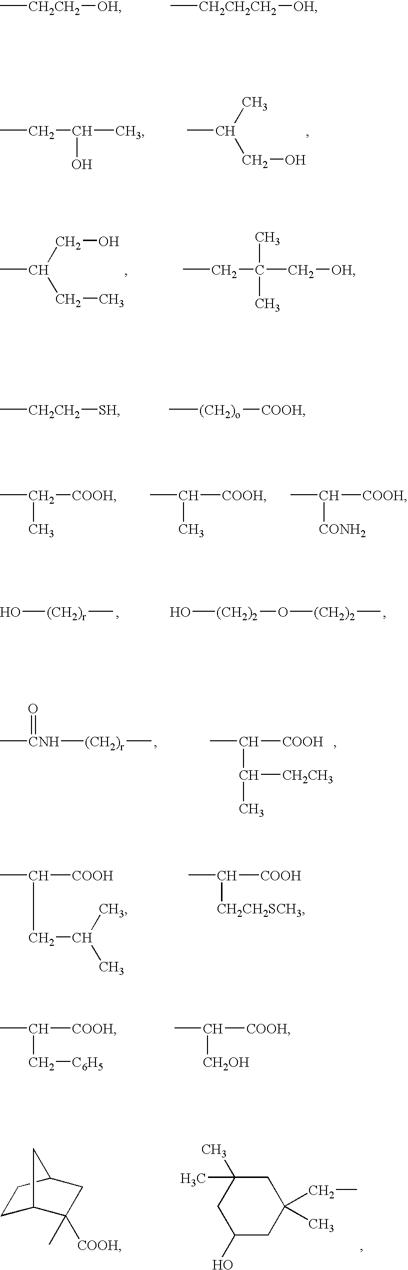

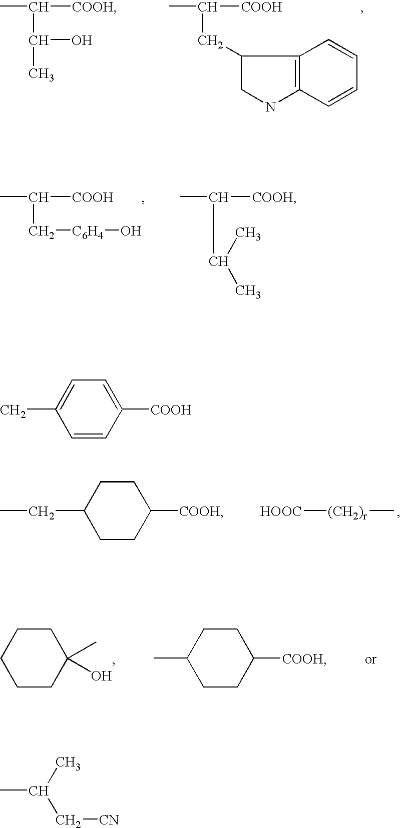

where o=from 1 to 21 and r=from 1 to 20.

n is preferably from 1 to 40, particularly preferably 1.

The radicals R³, R⁴, R⁵ and R⁶ are preferably C₁-C₆-alkyl, in particular C₁-C₄-alkyl, e.g. methyl, ethyl, propyl, butyl, pentyl, hexyl. Methyl and ethyl are particularly preferred.

For the purposes of the present invention, the term aryl is in particular phenyl or its C₁-C₄-alkyl- or C₁-C₄-alkoxy-substituted derivatives, such as tolyl, xylyl or else halophenyl, or unsubstituted or substituted naphthyl.

For the purposes of the present invention, C₃-C₁₂-cycloalkyl is preferably

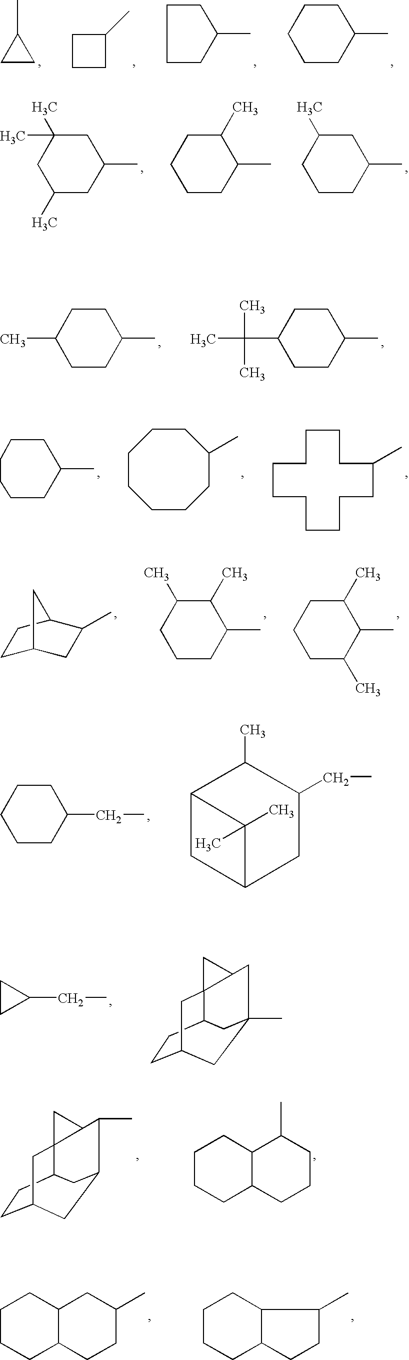

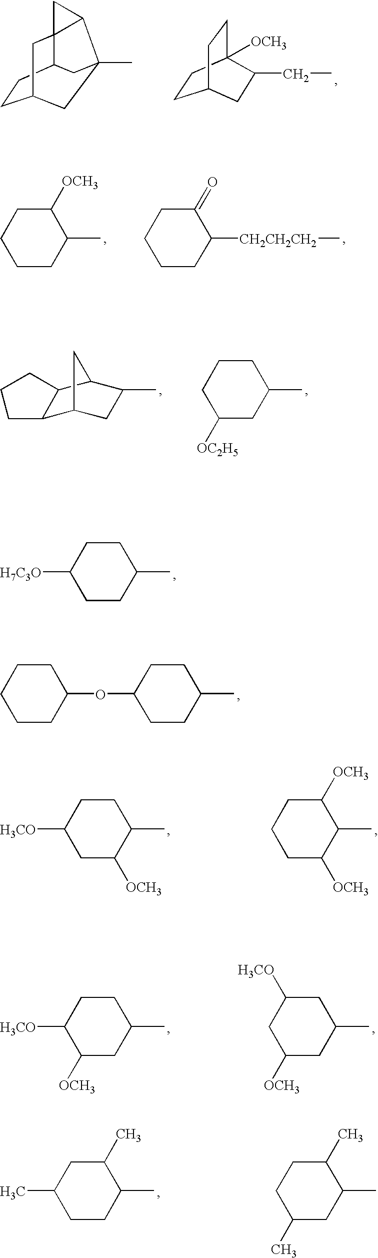

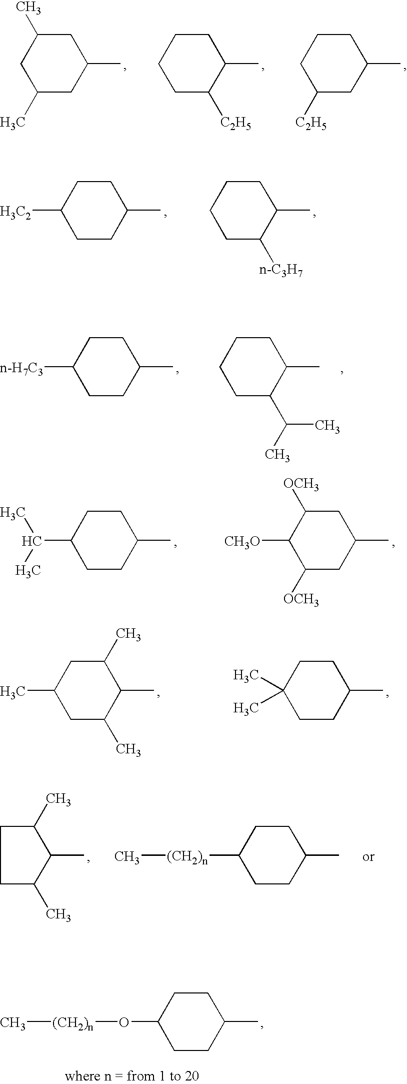

The radicals R⁷ and R⁸ are preferably hydrogen or C₁-C₄-alkyl, such as methyl. The term C₁-C₂₂-alkyl used here includes straight-chain and branched radicals, in particular C₁-C₆-alkyl, such as methyl, ethyl, n-propyl, isopropyl, butyl, pentyl, and hexyl. Examples of other branched alkyl radicals are the following:

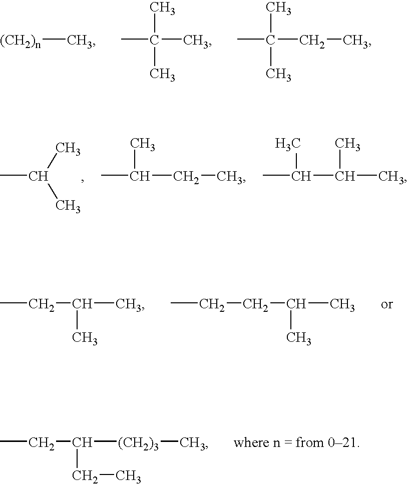

For the purposes of the present invention, C₇-C₁₂-aralkyl is preferably C₇-C₁₂-phenylalkyl, such as benzyl or phenylethyl, or else their C₁-C₄-alkyl- or C₁-C₄-alkoxy-substituted derivatives,

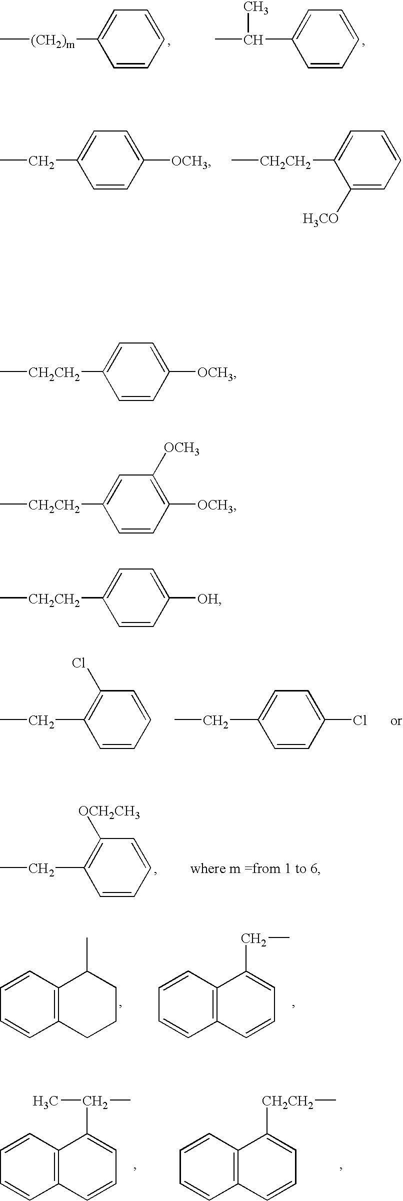

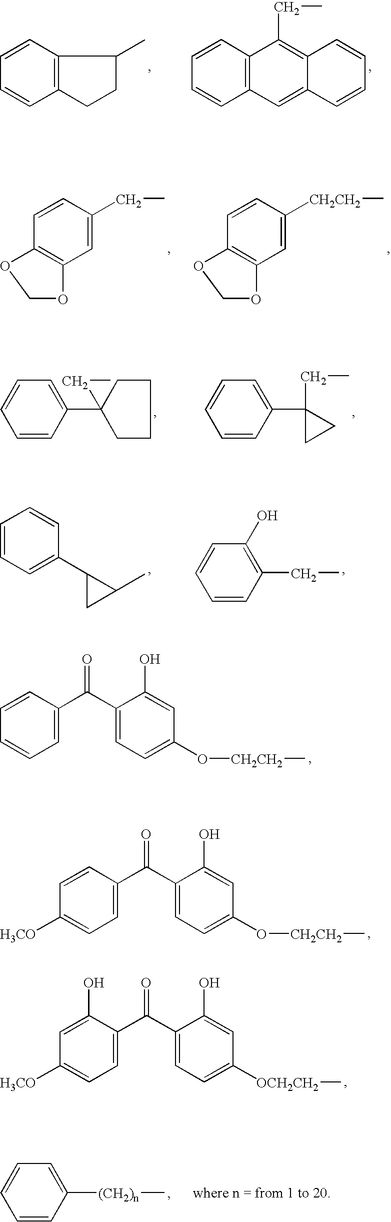

For the purposes of the present invention, a carboxylic ester is in particular the group

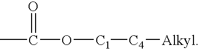

For the purposes of the present invention, C₃-C₂₂-alkenyl includes straight-chain and branched radicals, and also polyunsaturated radicals. Preference is given to C₃-C₁₂-alkenyl, such as allyl, butenyl, pentenyl, hexenyl, or heptenyl.

For the purposes of the present invention, C₃-C₂₂-alkynyl is a straight-chain or branched, mono- or polyunsaturated radical. Preference is given to C₃-C₁₂-alkynyl, such as propargyl, butynyl, pentynyl, hexynyl or octynyl.

For the purposes of the present invention, an example of an “oligomeric or polymeric polyamine” is the group

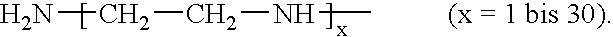

For the purposes of the present invention, an example of unsubstituted or substituted carbamoyl is (R¹³)₂NCO—, where R¹³ is hydrogen or C₁-C₄-alkyl.

Bridging units A and B are bivalent aliphatic, araliphatic, or aromatic groups which may, where appropriate, contain oxygen, nitrogen, or sulfur as heteroatoms. They may have the groups —CO—O—, —CO—NR¹⁴, —SO₂—O—, —SO₂—NR¹⁴—, particularly as terminal groups, where R¹⁴ is hydrogen, C₁-C₈-alkyl, C₇-C₁₂-aralkyl, C₂-C₄-hydroxyalkyl, C₅-C₇-cycloalkyl, C₇-C₁₂-cycloalkylalkyl, or is C₂-C₉-alkyl containing ethereal oxygen.

R¹⁴ may in particular be hydrogen, methyl, ethyl, propyl, butyl, pentyl, hexyl, heptyl, octyl, methylpropyl, benzyl, phenylethyl, methoxyphenylethyl, 2-hydroxyethyl, 2-hydroxypropyl, cyclopentyl, cyclohexyl, cycloheptyl, or methylcyclohexyl.

Examples of alkyl groups R¹⁴ containing ethereal oxygen are:

(CH₂)₃OCH₃, (CH₂)₃OC₂H₅, (CH₂)₃OC₃H₇, (CH₂)₃OC₄H₉, (CH₂)₂O(CH₂)₂O CH₃, (CH₂)₂O(CH₂)₂OCH₂H₅, (CH₂)₂O(CH₂)₂OC₃H₇, (CH₂)₃O(CH₂)OC₄H₉, (C₂H₄O)₃C₂H₅, (C₂H₄O)₃C₄H₉,

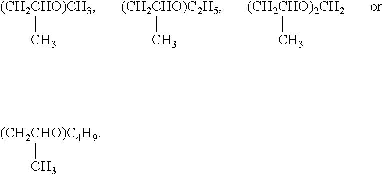

Particular radicals which may be mentioned for A and B are alkylene, cycloalkylene, aralkylene, and CO— or SO₂-substituted alkylene or CO— or SO₂-substituted aralkylene.

Examples of particular bridging units are:

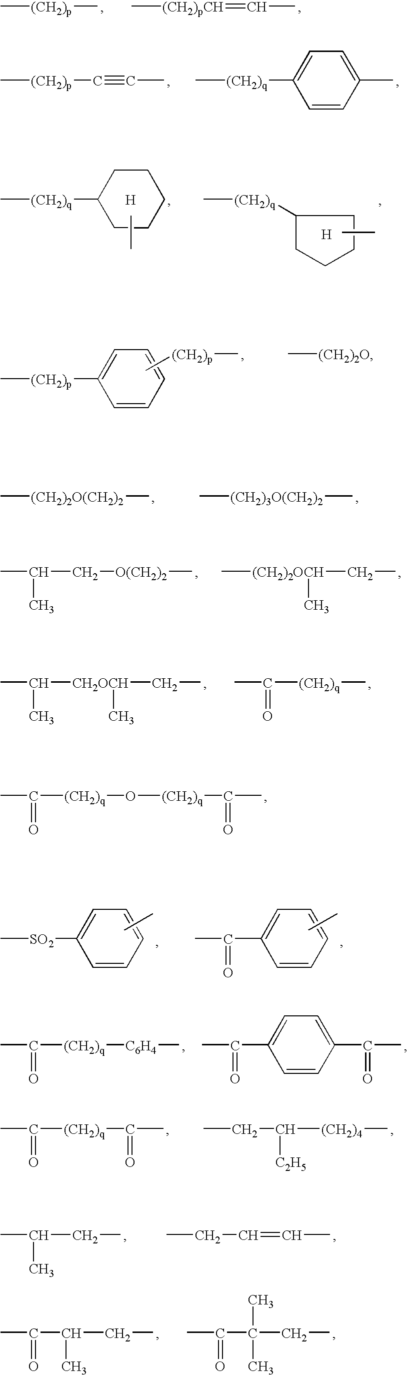

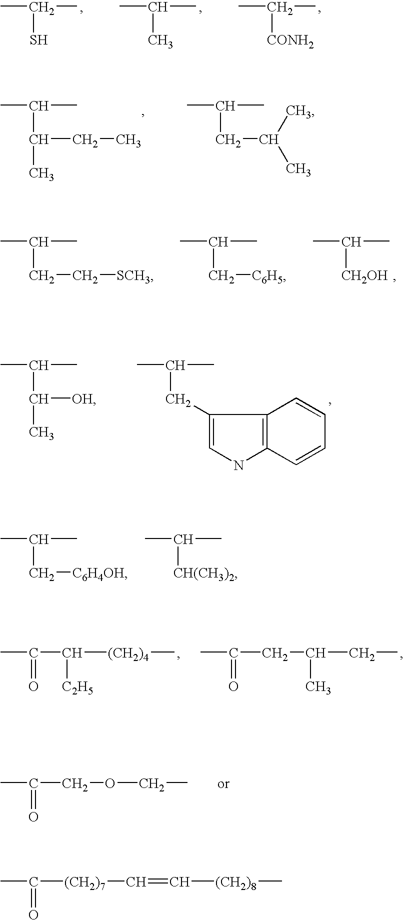

where p=from 1 to 20 and q=from 0 to 4.

Other examples of bridging units -B- are:

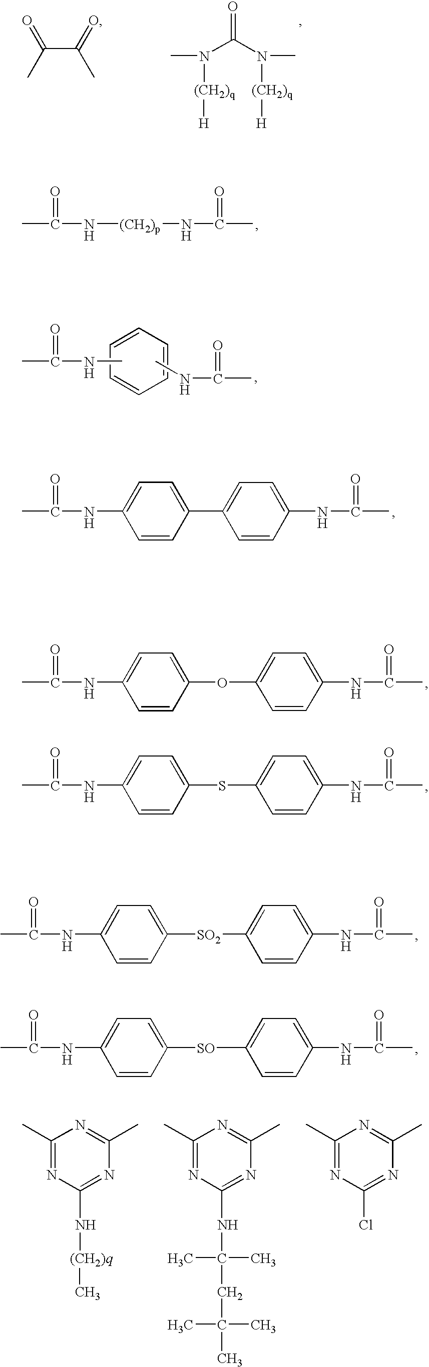

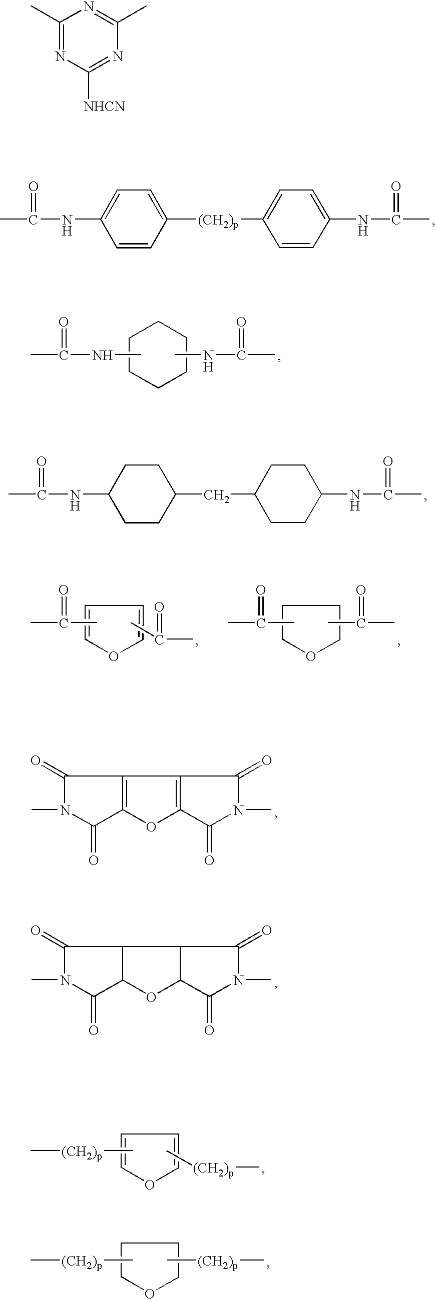

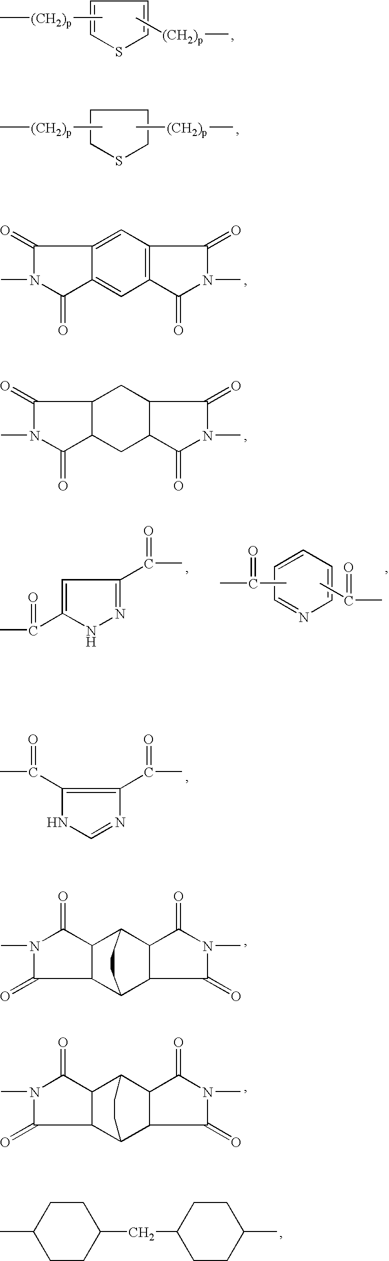

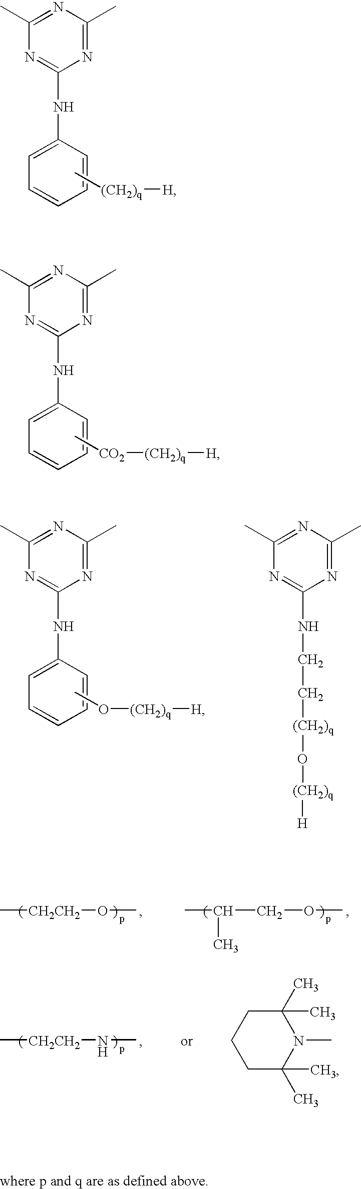

Preferred bridging units are (CH₂)ₙ, where n is in particular from 1 to 5, specifically 1, 2, or 5.

If heterocycles, in particular non-aromatic heterocycles, are present in the compounds b1), examples which may be given for these are the following:

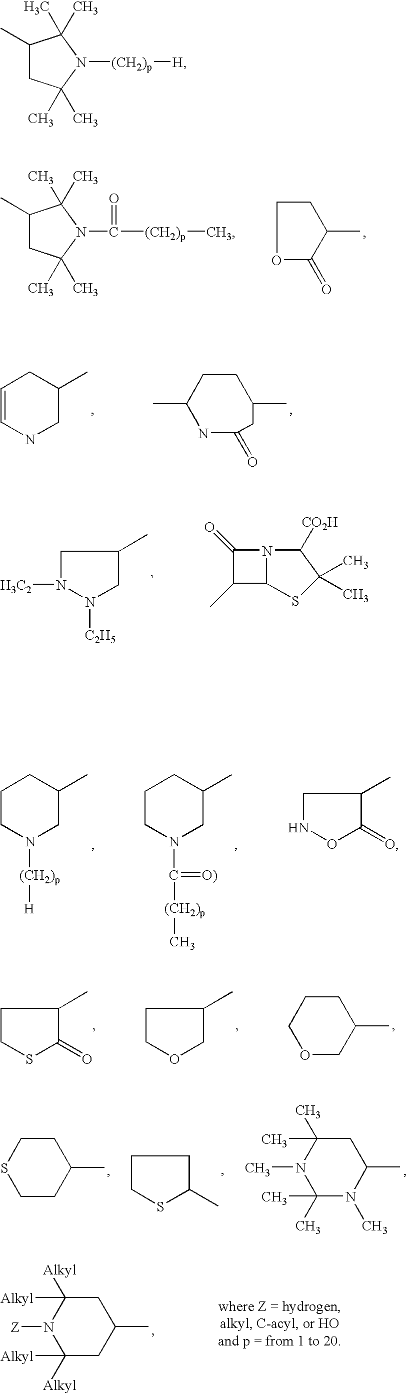

Examples of urea groups are the following:

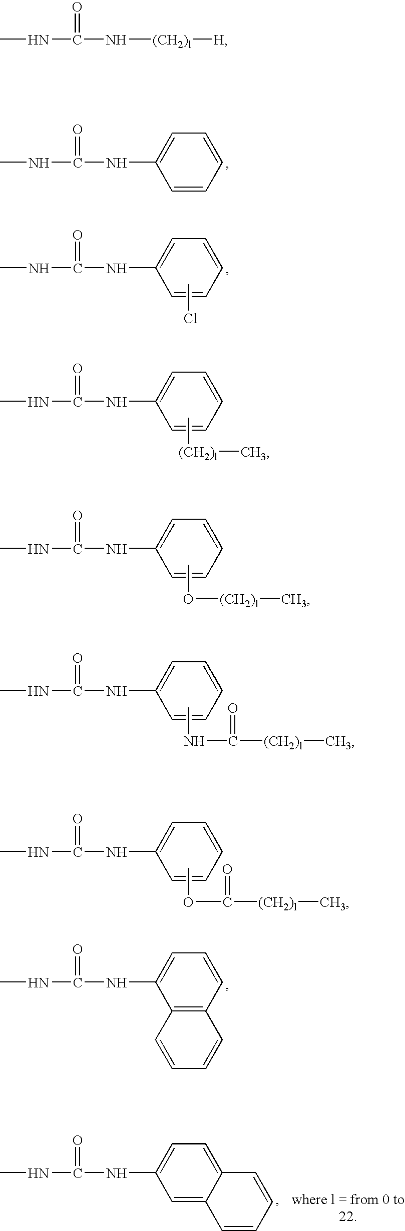

Examples of urethane groups are the following:

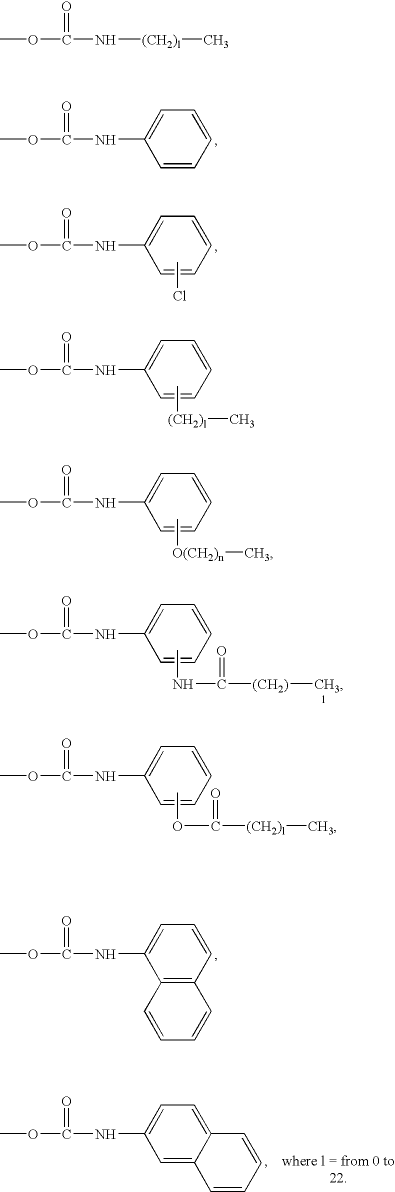

Y and Z, independently of one another, are in particular oxygen, or else sulfur, or —NR¹⁰.

R¹⁰ is hydrogen, C₁-C₈-alkyl, or C₇-C₁₂-aralkyl.

R¹¹ and R¹², independently of one another, are in particular hydrogen, or else

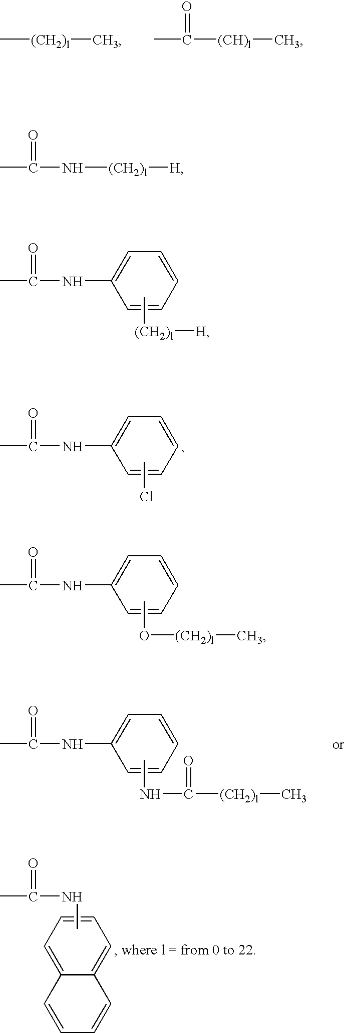

If R¹¹ and R¹² together with the nitrogen atom to which they are bonded form a ring system, examples of this ring system are:

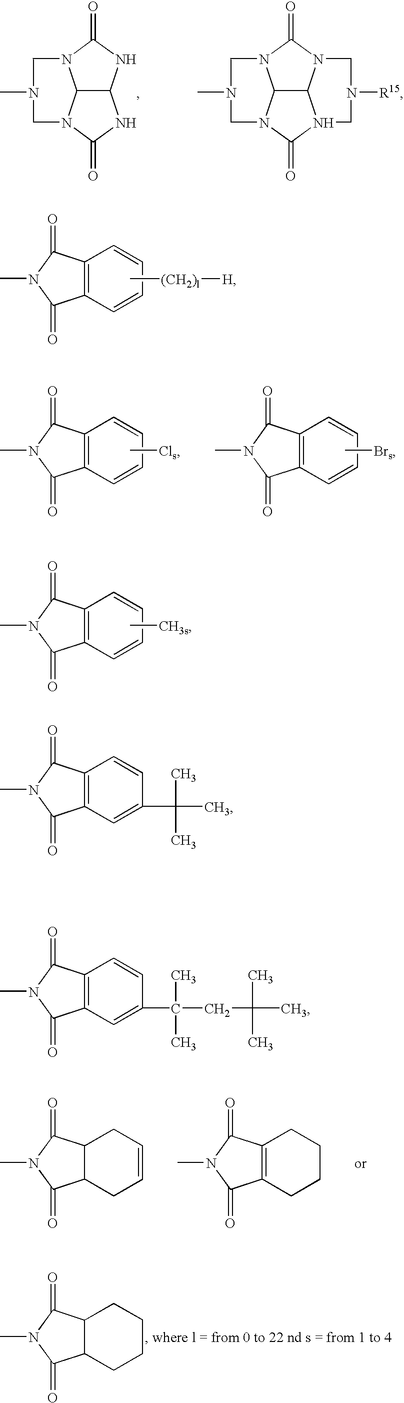

and R¹⁵ may assume any of the abovementioned definitions of R⁹.

Compounds of the formula (I) where n=1 and where the bridging unit A has the groups —CO—O, —CO—NR⁹—, —SO₂—NR⁹— may be prepared by reacting compounds of the formula II

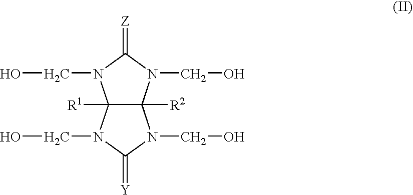

in a manner similar to that of the process of FR-A-2 291 203 with aminocarboxylic esters H₂N-B-COOR or aminosulfonic acids H₂-B-SO₃, or with the corresponding alkyl esters, such as ethyl esters, followed by catalytic transesterification or esterification using substituted piperidin-4-amines or piperidin-4-ols. The following scheme shows the reaction sequence for a compound III serving as an example.

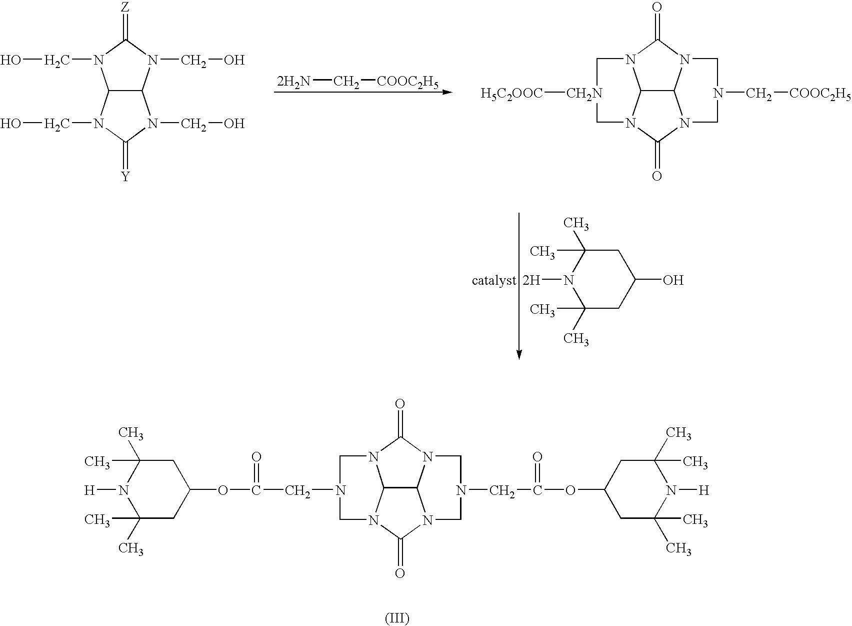

The catalyst for the second step of the reaction may be an alkali metal alkoxide, such as sodium methoxide, an alkali metal hydroxide, such as sodium hydroxide, an acid, or preferably a tetraalkyl orthotitanate, such as tetrabutyl orthotitanate.

Compounds of the formula I may also be prepared by reacting compounds of the formula II with compounds of the formula IV

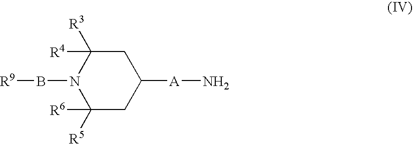

The compound of the formula II may be prepared here in situ by reacting compounds of the formula V

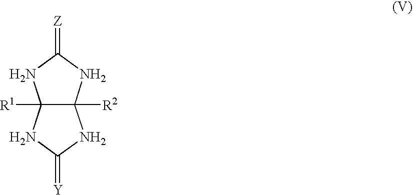

with formaldehyde or with a source of formaldehyde.

Processes known from the literature, e.g. reductive amination, may be used to convert the compounds of the formula I (where B-R⁹═H) into the compounds where, for example, B-R⁹═CH₃.

Compounds of the general formula I where R⁹ is —(CH₂)—CN may also be prepared advantageously by reacting compounds of the general formula VI

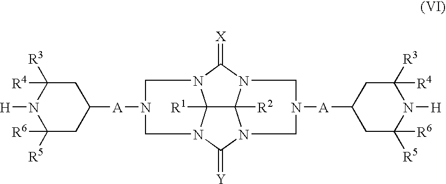

with glycolonitrile or with a source of glycolonitrile. DE-A-3 208 570 describes the reaction of glycolonitrile with sterically hindered amines.

The compounds b1) may be in the form of the free bases, or hydrates, or salts. Examples of suitable anions derive from inorganic acids, and in particular from organic carboxylic acids or else from organic sulfonic acids.

Examples of inorganic anions are chloride, bromide, sulfate, methosulfate, tetrafluoroborate, phosphate, and thiocyanate.

Examples of carboxylic anions are formate, acetate, propionate, hexanoate, cyclohexanoate, lactate, stearate, dodecylbenzoate, benzoate, acrylate, methacrylate, citrate, malonate, and succinate, and also anions of polycarboxylic acids having up to 3000 COOH groups.

Examples of sulfonic anions are benzenesulfonate and tosylate.

Other details concerning the amines b1) can be found in EP-A 272 590.

The amine b1) used and based on glycolurils is particularly preferably the compound of the formula (b1)

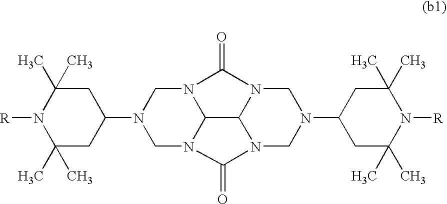

where R is hydrogen or methyl. Where R═H the compound is commercially available as Uvinul® 4049 H from BASF.

b2) Amines Based on 4-formylaminopiperidines (Group b2))

The amines used and based on 4-formylaminopiperidines are preferably the compounds of the formula (I)

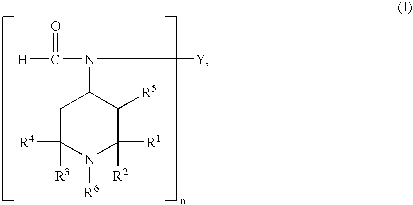

where

n is 1 or 2,

R¹, R², R³ and R⁴, independently of one another, are C₁-C₄-alkyl, or

R¹ and R² or R³ and R⁴ together are tetramethylene or pentamethylene,

R⁵ is hydrogen or C₁-C₄-alkyl,

R⁶ is hydrogen, C₁-C₂₂-alkyl, C₃-C₂₂-alkenyl, unsubstituted or C₁-C₄-alkyl-, fluorine-, chlorine-, C₁-C₄-alkoxy-, methylenedioxy-, ethylenedioxy-, and/or di-C₁-C₄-alkylamino-substituted C₇-C₁₂-phenylalkyl, C₁-C₂₂-alkanoyl, C₂-C₃-cyanoalkyl, C₁-C₂₂-hydroxyalkyl, or C₂-C₂₂-aminoalkyl, and

if n=1-

Y is hydrogen, C₁-C₂₂-alkyl, C₃-C₂₂-alkenyl, C₃-C₁₂-cycloalkyl or bicycloalkyl, cyano-, hydroxy-, or carbo-C₁-C₄-alkoxy-substituted C₂-C₂₂-alkyl, or is C₄-C₂₂-alkyl interrupted by ethereal oxygen, nitrogen, or sulfur, or is unsubstituted or C₁-C₄-alkyl-, fluorine-, chlorine-, C₁-C₄-alkoxy-, methylenedioxy-, ethylenedioxy- or di-C₁-C₄-alkylamino-substituted C₇-C₂₂-phenyl or diphenylalkyl, or unsubstituted or C₁-C₄-alkyl- or carbo-C₁-C₄-alkoxy-substituted phenyl, C₁-C₂₂-alkyl containing heterocyclic radicals, or a radical of the formula

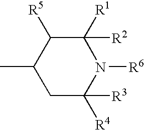

if n=2-

Y is C₂-C₂₂-alkylene, C₅-C₂₂-cycloalkylene, C₈-C₁₄-phenylalkylene, or phenylene, or is C₄-C₃₀-alkylene interrupted by ethereal oxygen, nitrogen, by sulfur, or by 5- or 6-membered heterocycles,

or else the acid adduct salts of these compounds.

The compounds b2) have exceptionally good stabilizing properties, have no intrinsic color, have good compatibility with organic polymers, have a low vapor pressure, and are stable with respect to thermal decomposition.

R¹ to R⁴ are preferably methyl. R⁵ is preferably hydrogen.

Examples of particular radicals which may be used for R⁶, other than hydrogen, are: methyl, ethyl, propyl, butyl, pentyl, hexyl; benzyl, phenylethyl, phenylpropyl, methylbenzyl; allyl; acetyl, propionyl, butanoyl, pentanoyl, benzoyl; cyanomethyl, hydroxyethyl, and aminoethyl.

R⁶ is preferably methyl, acetyl, cyanomethyl, aminoethyl, or in particular hydrogen.

Examples of radicals which may be mentioned for Y, other than hydrogen, are:

a) C₁-C₂₂-alkyl, such as methyl, ethyl, n-propyl, isopropyl, n-butyl, isobutyl, n-pentyl, isopentyl, hexyl, octyl, decyl, dodecyl, octadecyl, pivalyl, 3,3-dimethylbut-2-yl, neopentyl, 4-methyl-pent-2-yl, and 2-ethylhexyl;

b) C₃-C₂₂-alkenyl, such as allyl, butenyl, pentenyl, or oleyl;

c) C₃-C₁₂-cycloalkyl, such as cyclopropyl, cyclobutyl, cyclopentyl, cyclohexyl, methylcyclohexyl, cycloheptyl, cyclooctyl, cyclododecyl, and bicycloheptyl, among which preference is given to cyclopentyl and cyclohexyl;

d) cyano-, hydroxy-, or carboalkoxy-substituted C₂-C₂₂-alkyl, such as cyanomethyl, hydroxyethyl, hydroxypropyl, hydroxybutyl, carbomethoxyethyl and carboethoxyethyl;

e) C₄-C₂₂-alkyl interrupted by ethereal oxyten or by nitrogen and with or without hydroxyl substitution, such as —(CH₂)₃N(CH₃)₂, —(CH₂)₃N(C₂H₅)₂, —(CH₂)₃—OCH₃, —(CH₂)₃—O—CH(CH₃)₂, —(CH₂ )₂O—(CH₂)₂—OH, —CH₂—(CH₂)₂—CH₂—N(CH₂)₃, —(CH₂)₂—N[CH(CH₃)₂]₂, —(CH₂)₂—N(C₂H₅)₂, —(CH₂)₂N(CH₃)₂, —(CH₂)₂OCH₃ or —(CH₂)₂O CH₂CH₃;

f) unsubstituted or substituted C₇-C₂₂-phenyl- and diphenylalkyl, such as benzyl, methoxybenzyl, methylbenzyl, ethylbenzyl, isopropylbenzyl, trimethylbenzyl, fluorobenzyl, chlorobenzyl, methylenedioxybenzyl, phenylethyl, phenylpropyl, phenylbutyl, dimethylaminobenzyl, diphenylmethyl, and 1,3-diphenylprop-2-yl;

g) unsubstituted or substituted phenyl, such as phenyl, tolyl, or carbo-C₁-C₄-alkoxy-substituted phenyl;

h) heterocyclic radicals of the formula

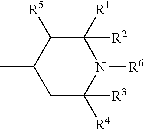

where R¹ to R⁶ are as defined above;

i) C₁-C₂₂-alkyl containing heterocycles, for example

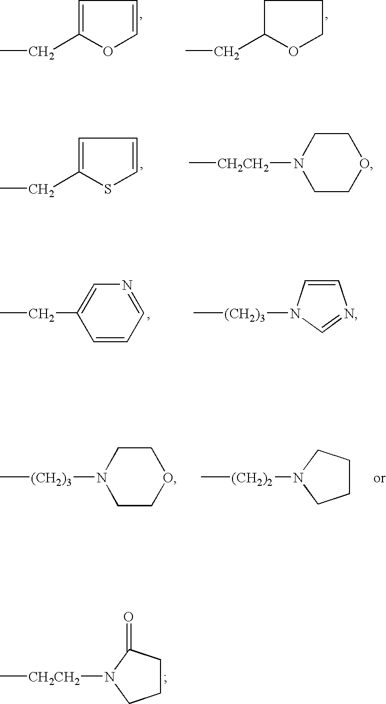

k) C₂-C₂₂-alkylene and C₅-C₂₂-cycloalkylene, such as —(CH₂)ₒ—CH₂ (where o=1 to 21),

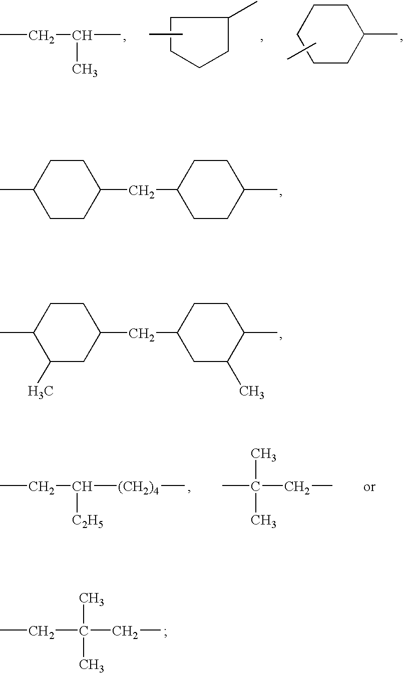

l) C₈-C₁₄-phenylalkylene and phenylene, such as

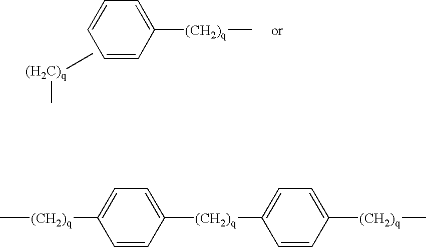

where q=from 1-4

m) alkylene interrupted by ethereal oxygen, by nitrogen, or by heterocycles, for example

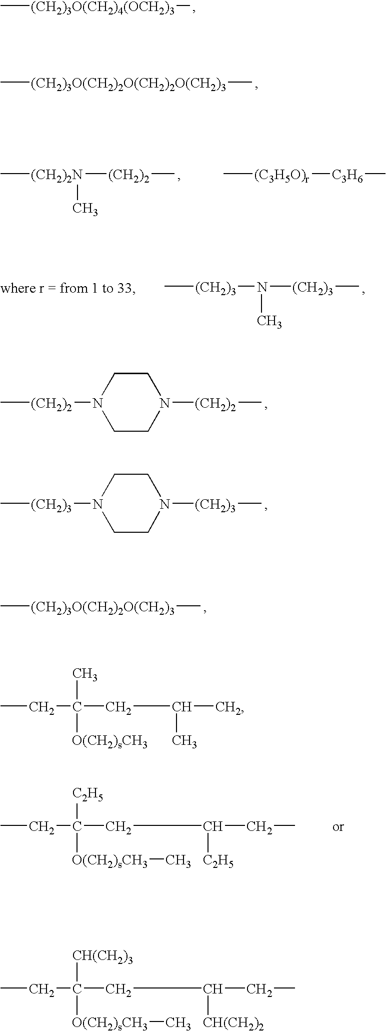

where s=from 0 to 7.

Compounds of the formula (I) may be prepared by reacting compounds of the formula (II) below with formic acid or formic esters. The methyl and ethyl esters are preferred for this purpose. Use of acatalyst here is optional. These catalysts may be Lewis acids, among which mention should particularly be made of titanium orthoesters, and specifically at this juncture titanium orthobutylate.

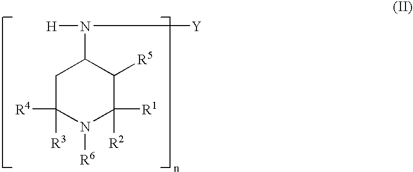

Compounds of the formula (I) where R⁶=H may be converted by processes known per se, such as alkylation, reductive amination, reaction with glycolonitrile inter alia into compounds of the formula (I) where R⁶≠H.

The compounds b2) may be in the form of the free bases or of salts. Examples of suitable anions derive from inorganic acids and in particular from organic carboxylic acids, or else from organic sulfonic acids.

Examples which may be mentioned of inorganic anions are chloride, bromide, sulfate, methosulfate, tetrafluoroborate, phosphate, and thiocyanate.

Examples of carboxylic anions which may be used are formate, acetate, propionate, hexanoate, cyclohexanoate, lactate, stearate, dodecylbenzoate, benzoate, acrylate, methacrylate, citrate, malonate, and succinate, and also anions of polycarboxylic acids having up to 3000 COOH groups.

Examples of sulfonic anions are benzenesulfonate and tosylate.

Other details concerning the amines b2) can be found in EP-A 316 582.

The amine b2) used and based on 4-formylaminopiperidines is particularly preferably the compound of the formula (b2)

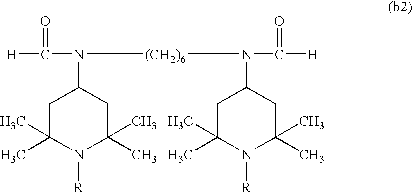

where R is hydrogen or methyl. With R═H it is commercially available as Uvinul® 4050 H from BASF.

b3) Amines Based on Maleimide-α-olefin Copolymers (Group b3))

The amines used and based on maleimide-α-olefin copolymers are preferably compounds composed of structural units of the formula (I)

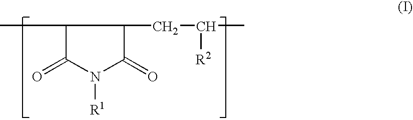

where R¹ is a tetramethylpiperidinyl radical of the formula II

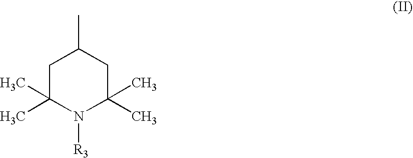

where R³ is hydrogen, C₁-C₆-alkyl, formyl, C₂-C₆-alkanoyl, C₁-C₁₂-alkoxy, C₅-C₆-cycloalkoxy, cyanomethyl, 2-hydroxyethyl, benzyl, or a radical of the formula —CR⁴═CH—CO—OR⁵, where

R⁴ is hydrogen, C₁-C₆-alkyl, or a radical of the formula —CO—OR⁵, and

R⁵ is C₁-C₁₈-alkyl, C₅-C₈-cycloalkyl, C₇-C₁₈-aralkyl, phenyl, or tolyl,

where

up to 8 mol % of R¹, based on II, may also be hydrogen, C₁-C₂₂-alkyl, or C₅-C₈-cycloalkyl, and

R² is a mixture of C₁₄-C₂₈-alkyl groups, where two of these alkyl groups which may not differ by more than two carbon atoms in each case make up at least 30% of this mixture,

with an average molecular weight of from 1000 to 50 000.

Preference is given to maleimide-α-olefin copolymers with an average molecular weight of from 1500 to 10 000, in particular from 2000 to 5000. The molecular weights given are number averages.

The radical R² is a mixture of C₁₄-C₂₈-alkyl groups, preferably C₁₆-C₂₄-alkyl groups, in particular C₁₈-C₂₂-alkyl groups, and the copolymer is therefore based on C₁₆-C₃₀ α-olefin units, preferably C₁₈-C₂₆ α-olefin units, in particular C₂₀-C₂₄ α-olefin units. R² is preferably a linear alkyl group.

For the purposes of the present invention, the presence of a mixture of alkyl groups for R² implies that two defined alkyl groups which may differ by not more than two carbon atoms in each case make up at least 30%, preferably in each case at least 40%, of this mixture, when a statistical average is taken across the entirety of all the copolymer molecules present. In particular, they are mixtures of 3 defined alkyl groups, e.g. octadecyl, eisocyl, and docosyl, where two of these groups which differ by 2 carbon atoms make up more than 40% and the third group makes up from 3 to 18% of the mixture. Very small amounts, usually less than 2%, of other alkyl groups having somewhat fewer than 18 or somewhat more than 22 carbon atoms may be present in the mixture.

The alkyl radicals described as C₁-C₆ (for R³ and R⁴), C₁-C₁₈ (for R⁵), and C₁-C₂₂ (for R¹) may be branched or in particular straight-chain members of the group, and therefore especially methyl, ethyl, n-propyl, isopropyl, n-butyl, isobutyl, sec-butyl, tert-butyl, n-amyl, isoamyl, sec-amyl, tert-amyl, neopentyl, n-hexyl, n-heptyl, n-octyl, 2-ethylhexyl, n-nonyl, isononyl, n-decyl, n-undecyl, n-dodecyl, n-tridecyl, isotridecyl, n-tetradecyl, n-pentadecyl, n-hexadecyl, n-heptadecyl, n-octadecyl, n-nonadecyl, n-eicosyl, or n-docosyl.

Straight-chain or branched C₂-C₆-alkanoyl radicals which may be used for R³ are especially acetyl, but also propionyl, butyryl, isobutyryl, pentanoyl, and hexanoyl.

Straight-chain or branched C₁-C₁₂-alkoxy groups which are especially suitable for R³ are C₆-C₈-alkoxy groups, such as n-hexoxy, isohexoxy, n-octoxy, 2-ethylhexoxy, and isooctoxy, and also methoxy, ethoxy, n-propoxy, isopropoxy, n-butoxy, isobutoxy, sec-butoxy, tert-butoxy, n-pentoxy, n-nonoxy, n-decoxy, n-undecoxy, and n-dodecoxy.

C₅-C₆-Cycloalkoxy groups for R³ are especially cyclopentoxy or cyclohexoxy.

C₅-C₈-Cycloalkyl radicals which may be used for RI and R⁵ are especially cyclopentyl and cyclohexyl, and also cycloheptyl, cyclooctyl, methylcyclopentyl, dimethylcyclopentyl, methylcyclohexyl, ethylcyclohexyl-, and dimethylcyclohexyl.

Examples of C₇-C₁₈-aralkyl radicals suitable for R⁵ are naphthylmethyl, diphenylmethyl, and methylbenzyl, and in particular C₇-C₁₈-phenylalkyl, such as 1-phenylethyl, 2-phenylethyl, 1-phenylpropyl, 2-phenylpropyl, 3-phenylpropyl, 2-phenylprop-2-yl, 4-phenylbutyl, 2,2-dimethyl-2-phenylethyl, 5-phenylamyl, 10-phenyldecyl, 12-phenyldodecyl, and especially benzyl.

Tolyl radicals which may be used are ortho-tolyl, meta-tolyl, and especially p-tolyl.

The radical R¹ is preferably a tetramethylpiperidinyl radical II, where R³ is hydrogen, C₁-C₆-alkyl, in particular methyl, or a radical of the formula —CH═CH—CO—OR⁶, where R⁶ is C₁-C₆-alkyl, in particular methyl or ethyl.

The presence of up to 8 mol %, in particular up to 5 mol %, based on II, of hydrogen, C₁-C₂₂-alkyl, or C₅-C₈-cycloalkyl as substituent R¹ on the maleimide nitrogen implies, for the purposes of the present invention, that this mixture of tetramethylpyridinyl radicals II and other substituents RI may be present, when the statistical average is taken across the entirety of all of the copolymer molecules present having structural units I. The incorporation of very small amounts of radicals R¹ other than tetramethylpiperidinyl substituents brings about a minor modification of the properties of the maleimide α-olefin copolymers b2).

One way of preparing the maleimide-α-olefin copolymers is to react maleic anhydride-α-olefin copolymers composed of structural units of the formula II

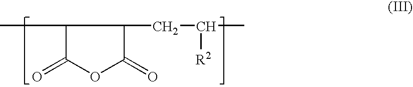

with 4-aminotetramethylpiperidines of the formula IV

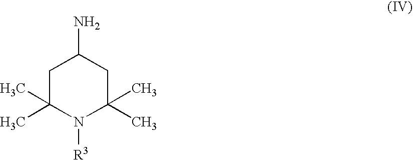

and, if desired, up to 8 mol %, in particular up to 5 mol %, based on IV, of ammonia, C₁-C₂₂-alkylamine, or C₅-C₈-cycloalkylamine, at from 100 to 220° C. in an organic solvent. The molar ratio here of anhydride groups in III to primary amine IV is usefully 1:1 or approximately 1:1.

Suitable organic solvents are especially aromatic hydrocarbons, such as toluene, xylenes, or mesitylene, and halogenated or nitrated hydrocarbons, such as chlorobenzene, dichlorobenzenes, or nitrobenzene. Industrial mixtures of aromatic compounds of this type are particularly important. However, use may also be made of hydrocarbon mixtures free from aromatics, if their boiling range is sufficiently high.

The reaction temperature selected should preferably be in the range from 120 to 200° C., in particular from 140 to 175° C. The water formed during the reaction is usefully removed by azeotropic distillation. The reaction is normally carried out at atmospheric pressure and has generally proceeded to completion after from 1 to 5 hours.

The maleic anhydride-α-olefin copolymers used as starting material and having structural units III are obtainable from known preparation processes by polymerizing maleic anhydride with the appropriate α-olefin mixtures, for example by a method based on Houben-Weyl, Methoden der Organischen Chemie, Volume E20/2, pp. 1237-1248 (1987).

The maleimide α-olefin copolymers b3) having structural units I and the maleic anhydride-α-olefin copolymers used as starting material and having structural units III are very generally alternating 1:1 copolymers of maleic acid derivatives and olefin.

Further details concerning the amines b3) can be found in WO-A 94/12544.

Compounds of the formula (b3)

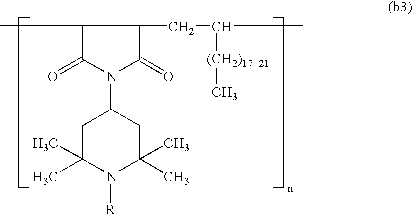

where R is C₁-C₆-alkyl may be prepared not only by reacting the copolymers of the formula III with the appropriate 1-alkyl-substituted 4-aminotetramethylpiperidines of the formula IV (i.e. R³ being C₁-C₆-alkyl), but also for example by polymer-analogous alkylation using familiar alkylating agents, starting from compounds of the formula (b3) where R is hydrogen.

The polymer-analogous introduction of a methyl group in the 1-position of the piperidine ring (i.e. R in formula (b3) being methyl) is elegantly achieved by means of a Leuckart-Wallach reaction, likewise starting from the corresponding unsubstituted compound. Here, the unsubstituted copolymer is usually dissolved in an inert, organic solvent, e.g. as described above for the reaction of the maleic-anhydride-α-olefin copolymers of the formula III with 4-aminotetramethylpiperidines of the formula IV, and reacted in succession with formaldehyde and formic acid at an elevated temperature. Pages 8 and 9 of the publication WO 01/74777 give a summary of further details concerning the reaction conditions.

The amine b3) used is particularly preferably maleimide-α-olefin copolymers of the formula (b3), where R is hydrogen or methyl and the selection of n is such that the molecular weight is about 3500. With R═H, the compound is commercially available as Uvinul® 5050 H from BASF.

Quantitative Proportions

The stabilizers are present in the usual amounts in the molding compositions of the invention. The total amount of the stabilizers (total of all of the amines b1) to b4)) is preferably from 0.001 to 10% by weight, particularly preferably from 0.1 to 5% by weight, and in particular from 0.2 to 1% by weight, based on the stabilized thermoplastic molding composition.

The preferred proportions of the individual amines b1), b2), b3), and b4) depend in a known manner on the desired property profile of the stabilized thermoplastic molding composition of the invention and are a function of the properties of the (unstabilized) polyolefin A used.

The proportions in particularly preferred embodiments are

from 0.1 to 0.3% by weight of the component compound having the above formula b1) (e.g. Uvinul® 4049 H),

from 0.1 to 0.5% by weight of the component compound having the above formula b2) (e.g. Uvinul® 4050 H),

from 0.2 to 0.8% by weight of the component compound having the above formula b3) (e.g. Uvinul® 5050 H),

based in each case on the stabilized thermoplastic molding composition.

Optional Component C)

If desired, another component C) or two or more other components C′), C″), etc. may be present in the molding compositions of the invention.

Suitable components C) are selected from polymers other than the polyolefins A) and from additives other than the stabilizers B). Examples which may be mentioned of polymers C) are:

polyolefins not prepared using metallocene catalysts,

vinyl polymers, in particular homo- and copolymers of styrene or of vinyl chloride,

fluorohomo- and copolymers,

acrylic and methacrylic polymers, poly(meth)acrylates,

polyoxymethylenes,

polyamides,

aromatic polyesters, in particular polycarbonates and polyesters of terephthalic acid,

aromatic polysulfides and -sulfones,

aromatic polyethers,

aliphatic polyesters (polyglycols),

polyaryl ether ketones,

polyimides,

liquid-crystalline polymers,

polyurethanes,

thermoplastic elastomers,

naturally occuring polymers, e.g. based on cellulose or on starch,

photodegradable or biodegradable polymers and water-soluble polymers,

electrically conductive polymers.

These polymers are known and are described by way of example in Saechtling (ed.), Kunststoff-Taschenbuch, 27^{th} edition, Hanser-Verlag Munich 1998, pp. 371-595. They are commercially available, and no-further details need therefore be given.

Particularly suitable as component C) are other additives. These additives C) are, of course, additives other than the stabilizers B). Examples of other additives C) of this type are given below under Nos. 1 to 14.

1. Antioxidants

1.1. Alkylated monophenols, for example

2,6-di-tert-butyl-4-methylphenol, 2-butyl-4,6-dimethylphenol,

2,6-di-tert-butyl-4-ethylphenol,

2,6-di-tert-butyl-4-n-butylphenol,

2,6-di-tert-butyl-4-isobutylphenol,

2,6-dicyclopentyl-4-methylphenol,

2-(a-methylcyclohexyl)-4,6-dimethylphenol,

2,6-dioctadecyl-4-methylphenol, 2,4,6-tricyclohexylphenol,

2,6-di-tert-butyl-4-methoxymethylphenol, nonylphenols, having linear or branched side chains, for example

2,6-dinonyl-4-methylphenol,

2,4-dimethyl-6-(1-methylundec-1′-yl)phenol,

2,4-dimethyl-6-(1′-methylheptadec-1′-yl)phenol,

2,4-dimethyl-6-(1′-methyltridec-1′-yl)phenol, and mixtures thereof.

1.2. Alkylthiomethylphenols, for example

2,4-dioctylthiomethyl-6-tert-butylphenol,

2,4-dioctylthiomethyl-6-methylphenol,

2,4-dioctylthiomethyl-6-ethylphenol,

2,6-didodecylthiomethyl-4-nonylphenol.

1.3. Hydroquinones and alkylated hydroquinones, for example

2,6-di-tert-butyl-4-methoxyphenol, 2,5-di-tert-butylhydroquinone,

2,5-di-tert-amylhydroquinone, 2,6-diphenyl-4-octadecyloxyphenol,

2,6-di-tert-butylhydroquinone,

2,5-di-tert-butyl-4-hydroxyanisole,

3,5-di-tert-butyl-4-hydroxyanisole,

3,5-di-tert-butyl-4-hydroxyphenyl stearate,

bis(3,5-di-tert-butyl-4-hydroxyphenyl) adipate.

1.4. Tocopherols, for example α-tocopherol, β-tocopherol, γ-tocopherol, δ-tocopherol, and mixtures thereof (vitamin E).

1.5. Hydroxylated thiodiphenyl ethers, for example

2,2′-thiobis(6-tert-butyl-4-methylphenol),

2,2′-thiobis(4-octylphenol),

4,4′-thiobis(6-tert-butyl-3-methylphenol),

4,4′-thiobis(6-tert-butyl-2-methylphenol),

4,4′-thiobis(3,6-di-sec-amylphenol),

4,4′-bis(2,6-dimethyl-4-hydroxyphenyl) disulfide.

1.6. Alkylidenebisphenols, for example

2,2′-methylenebis(6-tert-butyl-4-methylphenol),

2,2′-methylenebis(6-tert-butyl-4-ethylphenol),

2,2′-methylenebis[4-methyl-6-(a-methylcyclohexyl)phenol],

2,2′-methylenebis(4-methyl-6-cyclohexylphenol),

2,2′-methylenebis(6-nonyl-4-methylphenol),

2,2′-methylenebis(4,6-di-tert-butylphenol),

2,2′-ethylidenebis(4,6-di-tert-butylphenol),

2,2′-ethylidenebis(6-tert-butyl-4-isobutylphenol),

2,2′-methylenebis(α-methylbenzyl)-4-nonylphenol],

2,2′-methylenebis[6-(α,α-dimethylbenzyl)-4-nonylphenol],

4,4′-methylenebis(2,6-di-tert-butylphenol),

4,4′-methylenebis(6-tert-butyl-2-methylphenol),

1,1-bis(5-tert-butyl-4-hydroxy-2-methylphenyl)butane,

2,6-bis(3-tert-butyl-5-methyl-2-hydroxybenzyl)-4-methylphenol,

1,1,3-tris(5-tert-butyl-4-hydroxy-2-methylphenyl)butane,

1,1-bis(5-tert-butyl-4-hydroxy-2-methylphenyl)-3-n-dodecyl mercaptobutane, ethylene glycol bis[3,3-bis(3′-tert-butyl-4′-hydroxyphenyl)butyrate],

bis(3-tert-butyl-4-hydroxy-5-methylphenyl)dicyclopentadiene,

bis[2-(3′-tert-butyl-2′-hydroxy-5′-methylbenzyl)-6-tert-butyl-4-methylphenyl] terephthalate,

1,1-bis(3,5-dimethyl-2-hydroxyphenyl)butane,

2,2-bis(3,5-di-tert-butyl-4-hydroxyphenyl)propane,

2,2-bis(5-tert-butyl-4-hydroxy-2-methylphenyl)-4-n-dodecyl-mercaptobutane, 1,1,5,5-tetra-(5-tert-butyl-4-hydroxy-2-methylphenyl)pentane.

1.7. O-, N- and S-benzyl compounds, for example

3,5,31,5′-tetra-tert-butyl-4,4′-dihydroxydibenzyl ether,

octadecyl, 4-hydroxy-3,5-dimethylbenzylmercaptoacetate, tridecyl 4-hydroxy-3,5-di-tert-butylbenzylmercaptoacetate,

tris(3,5-di-tert-butyl-4-hydroxybenzyl)amine,

bis(4-tert-butyl-3-hydroxy-2,6-dimethylbenzyl) dithioterephthalate, bis(3,5-di-tert-butyl-4-hydroxybenzyl) sulfide, isooctyl

3,5-di-tert-butyl-4-hydroxybenzylmercaptoacetate.

1.8. Hydroxybenzylated malonates, for example dioctadecyl 2,2-bis(3,5-di-tert-butyl-2-hydroxybenzyl)malonate, dioctadecyl 2-(3-tert-butyl-4-hydroxy-5-methylbenzyl)malonate, didodecyl mercaptoethyl-2,2-bis(3,5-di-tert-butyl-4-hydroxybenzyl)malonate, bis[4-(1,1,3,3-tetramethylbutyl)phenyl]2,2-bis(3,5-di-tert-butyl-4-hydroxybenzyl)malonate.

1.9. Aromatic hydroxybenzyl compounds, for example

1,3,5-tris(3,5-di-tert-butyl-4-hydroxybenzyl)-2,4,6-trimethyl-benzene,

1,4-bis(3,5-di-tert-butyl-4-hydroxybenzyl)-2,3,5,6-tetramethyl-benzene, 2,4,6-tris(3,5-di-tert-butyl-4-hydroxybenzyl)phenol.

1.10. Triazine compounds, for example

2,4-bis(octylmercapto)-6-(3,5-di-tert-butyl-4-hydroxyanilino)-1,3,5-triazine,

2-octylmercapto-4,6-bis(3,5-di-tert-butyl-4-hydroxyanilino)-1,3,5-triazine,

2-octylmercapto-4,6-bis(3,5-di-tert-butyl-4-hydroxyphenoxy)-1,3,5-triazine,

2,4,6-tris(3,5-di-tert-butyl-4-hydroxyphenoxy)-1,2,3-triazine,

1,3,5-tris(3,5-tert-butyl-4-hydroxybenzyl) isocyanurate,

1,3,5-tris(4-tert-butyl-3-hydroxy-2,6-dimethylbenzyl) isocyanurate,

2,4,6-tris(3,5-di-tert-butyl-4-hydroxyphenylethyl)-1,3,5-triazine,

1,3,5-tris(3,5-di-tert-butyl-4-hydroxyphenylpropionyl)hexahydro-1,3,5-triazine, 1,3,5-tris-(3,5-dicyclohexyl-4-hydroxybenzyl) isocyanurate.

1.11. Benzylphosphonates, for example dimethyl

2,5-di-tert-butyl-4-hydroxybenzylphosphonate, diethyl

3,5-di-tert-butyl-4-hydroxybenzylphosphonate, dioctadecyl

3,5-di-tert-butyl-4-hydroxybenzylphosphonate, dioctadecyl

5-tert-butyl-4-hydroxy-3-methylbenzylphosphonate, the Ca salt of the monoethyl ester of

3,5-di-tert-butyl-4-hydroxybenzylphosphonic acid.

1.12. Acylaminophenols, for example 4-hydroxylauranilide,

4-hydroxystearanilide,

octyl-N-(3,5-di-tert-butyl-4-hydroxyphenyl)carbamate.

1.13. Esters of B-(3,5-di-tert-butyl-4-hydroxyphenyl)propionic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of

β-(5-tert-butyl-4-hydroxy-3-methylphenyl)propionic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenylacetic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid, e.g.

N,N′-bis(3,5-di-tert-butyl-4-hydroxyphenylpropionyl)hexamethylene diamide,

N,N′-bis(3,5-di-tert-butyl-4-hydroxyphenylpropionyl)trimethylene diamide,

N,N′-bis(3,5-di-tert-butyl-4-hydroxyphenylpropionyl)hydrazide,

N,N′-bis[2-(3-[3,5-di-tert-butyl-4-hydroxyphenyl]propionyloxy) ethyl]oxamide.

1.18. Ascorbic Acid (Vitamin C)

1.19. Amine antioxidants, for example

N,N′-diisopropyl-p-phenylenediamine,

N,N′-di-sec-butyl-p-phenylenediamine,

N,N′-bis(1,4-dimethylpentyl)-p-phenylenediamine,

N,N′-bis(1-ethyl-3-methylpentyl)-p-phenylenediamine,

N,N′-bis(1-methylheptyl)-p-phenylenediamine,

N,N′-dicyclohexyl-p-phenylenediamine,

N,N′-diphenyl-p-phenylenediamine,

N,N′-bis(2-naphthyl)-p-phenylenediamine,

N-isopropyl-N-phenyl-p-phenylenediamine,

N-(1,3-dimethylbutyl)-N-phenyl-p-phenylenediamine,

N-(1-methylheptyl)-N′-phenyl-p-phenylenediamine,

N-cyclohexyl-N′-phenyl-p-phenylenediamine,

4-(p-toluenesulfamoyl)diphenylamine,

N,N′-dimethyl-N,N′-di-sec-butyl-p-phenylenediamine, diphenylamine, N-allyldiphenylamine, 4-isopropoxydiphenylamine,

N-phenyl-1-naphthylamine, N-(4-tert-octylphenyl)-1-naphthylamine,

N-phenyl-2-naphthylamine, octylated diphenylamine, e.g.

p,p′-di-tert-octyldiphenylamine, 4-n-butylaminophenol,

4-butyrylaminophenol, 4-nonanoylaminophenol,

4-dodecanoylaminophenol, 4-octadecanoylaminophenol,

bis(4-methoxyphenyl)amine,

2,6-di-tert-butyl-4-dimethylaminomethylphenol,

2,4′-diaminodiphenylmethane, 4,4′-diaminodiphenylmethane,

N,N,N′,N′-tetramethyl-4,4′-diaminodiphenylmethane,

1,2-bis[(2-methylphenyl)amino]ethane,

1,2-bis(phenylamino)propane, (o-tolyl)biguanide,

bis[4-(1′,3′-dimethylbutyl)-phenylamine, tert-octylated

N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines,

2,3-dihydro-3,3-dimethyl-4H-1,4-benzothiazine, phenothiazine, a mixture of mono- and dialkylated tert-butyl/tert-octyl-phenothiazines, a mixture of mono- and dialkylated tert-octylphenothiazines, N-allylphenothiazine,

N,N,N′,N′-tetraphenyl-1,4-diaminobut-2-ene,

N,N-bis(2,2,6,6-tetramethylpiperidin-4-yl)hexamethylenediamine,

bis(2,2,6,6-tetramethylpiperidin-4-yl) sebacate,

2,2,6,6-tetramethylpiperidin-4-one,

2,2,6,6-tetramethylpiperidin-4-ol.

2. UV Absorbers and Light Stabilizers

2.1. 2-(2′-Hydroxyphenyl)benzotriazoles, for example

2-(2′-hydroxy-5′-methylphenyl)benzotriazole,

2-(3′,5′-di-tert-butyl-2′-hydroxyphenyl)benzotriazole,

2-(5′-tert-butyl-2′-hydroxyphenyl)benzotriazole,

2-(2′-hydroxy-5′-(1,1,3,3-tetramethylbutyl)phenyl]benzotriazole,

2-(3′,5′-di-tert-butyl-2′-hydroxyphenyl)-5-chlorobenzotriazole,

2-(3′-tert-butyl-2′-hydroxy-5′-methylphenyl)-5-chlorobenzo-triazole,

2-(3′-sec-butyl-5′-tert-butyl-2′-hydroxyphenyl)benzotriazole,

2-(2′-hydroxy-4′-octyloxyphenyl)benzotriazole,

2-(3′,5′-di-tert-amyl-2′-hydroxyphenyl)benzotriazole,

2-(3′,5′-bis(α,α-dimethylbenzyl)-2′-hydroxyphenyl)benzotriazole,

2-(3′-tert-butyl-2′-hydroxy-5′-(2-octyloxycarbonylethyl)phenyl)-5-chlorobenzotriazole,

2-(3′-tert-butyl-5′-[2-(2-ethylhexyloxy)carbonylethyl]-2′-hydroxy phenyl)-5-chlorobenzotriazole,

2-(3′-tert-butyl-2′-hydroxy-5′-(2-methoxycarbonylethyl)phenyl)-5-chlorobenzotriazole,

2-(3′-tert-butyl-2′-hydroxy-5′-(2-methoxycarbonylethyl)phenyl) benzotriazole,

2-(3′-tert-butyl-2′-hydroxy-5′-(2-octyloxycarbonylethyl)phenyl) benzotriazole,

2-(3′-tert-butyl-5′-[2-(2-ethylhexyloxy)carbonylethyl]-2′-hydroxy phenyl)benzotriazole,

2-(3′-dodecyl-2′-hydroxy-5′-methylphenyl)benzotriazole, and

2-(3′-tert-butyl-2′-hydroxy-5′-(2-isooctyloxycarbonylethyl)phenyl benzotriazole,

2,2′-methylenebis[4-(1,1,3,3-tetramethylbutyl)-6-benzotriazol-2-ylphenol]; the transesterification product of

2-[3′tert-butyl-5′-(2-methoxycarbonylethyl)-2′-hydroxyphenyl]-2H-benzotriazole with polyethylene glycol 300;

[R—CH₂CH₂—COO—CH₂CH₂]₂—

where R=3′-tert-butyl-4′-hydroxy-5′-2H-benzotriazol-2-ylphenyl,

2-[2′-hydroxy-3′-(α,α-dimethylbenzyl)-51-(1,1,3,3-tetramethyl butyl)phenyl]benzotriazole;

2-[2′-hydroxy-3′-(1,1,3,3-tetramethylbutyl)-5′-(α,α-dimethyl benzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted or unsubstituted benzoic acids, for example 4-tert-butyl-phenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl-α-cyano-β,β-diphenylacrylate or isooctyl α-cyano-β,β-diphenylacrylate, methyl α-carbomethoxycinnamate, methyl α-cyano-β-methyl-β-methoxycinnamate or butyl α-cyano-β-methyl-β-methoxycinnamate, methyl α-carbomethoxy-β-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of monoalkyl esters, such as of the methyl or ethyl ester, of 4-hydroxy-3,5-di-tert-butylbenzylphosphonic acid, nickel complexes of ketoximes, e.g. of 2-hydroxy-4-methylphenyl undecyl ketoxime, nickel complexes of 1-phenyl-4-lauroyl-5-hydroxypyrazole, with or without additional ligands.

2.6. Oxalamides, for example 4,4′-dioctyloxyoxanilide,

2,2′-diethoxyanilide,

2,2′-dioctyloxy-5,5′-di-tert-butyloxanilide,

2,2′-didodecyloxy-5,5′-di-tert-butyloxanilide,

2-ethoxy-2′-ethyloxanilide,

N,N′-bis(3-dimethylaminopropyl)-oxalamide,

2-ethoxy-5-tert-butyl-2′-ethyloxanilide and its mixture with 2-ethoxy-2′-ethyl-5,4′-di-tert-butyloxanilide and mixtures of o- and p-methoxy-disubstituted oxanilides and of o- and p-ethoxy-disubstituted oxanilides.

2.7. 2-(2-Hydroxyphenyl)-1,3,5-triazines, for example

2,4,6-tris(2-hydroxy-4-octyloxyphenyl)-1,3,5-triazine,

2-(2-hydroxy-4-octyloxyphenyl)-4′,6-bis(2′,4-dimethylphenyl)-1,3,5-triazine,

2-(2,4-dihydroxyphenyl)-4,6-bis(2,4-dimethylphenyl)-1,3,5-triazine,

2,4-bis(2-hydroxy-4-propyloxyphenyl)-6-(2,4-dimethylphenyl)-1,3,5-triazine,

2-(2-hydroxy-4-octyloxyphenyl)-4,6-bis(4-methylphenyl)-1,3,5-triazine,

2-(2-hydroxy-4-dodecyloxyphenyl)-4,6-bis(2,4-dimethylphenyl)-1,3,5-triazine,

2-(2-hydroxy-4-tridecyloxyphenyl)-4,6-bis(2,4-dimethylphenyl)-1,3,5-triazine,

2-[2-hydroxy-4-(2-hydroxy-3-butyloxypropyloxy)phenyl]-4,6-bis(2,4-dimethyl)-1,3,5-triazine,

2-[2-hydroxy-4-(2-hydroxy-3-octyloxypropyloxy)phenyl]-4,6-bis(2,4-dimethyl)-1,3,5-triazine,

2-[4-dodecyloxy/tridecyloxy-2-hydroxypropoxy)-2-hydroxyphenyl]-4,6-bis(2,4-dimethylphenyl)-1,3,5-triazine,

2-[2-hydroxy-4-(2-hydroxy-3-dodecyloxypropoxy)phenyl]-4,6-bis(2,4-dimethylphenyl)-1,3,5-triazine,

2-(2-hydroxy-4-hexyloxy)phenyl-4,6-diphenyl-1,3,5-triazine,

2-(2-hydroxy-4-methoxyphenyl)-4,6-diphenyl-1,3,5-triazine,

2,4,6-tris[2-hydroxy-4-(3-butoxy-2-hydroxypropoxy)phenyl]-1,3,5-triazine,

2-(2-hydroxyphenyl)-4-(4-methoxyphenyl)-6-phenyl-1,3,5-triazine,

2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxalamide,

N-salicylal-N′-salicyloylhydrazine,

N,N′-bis(salicyloyl)hydrazine,

N,N′-bis(3,5-di-tert-butyl-4-hydroxyphenylpropionyl)hydrazine,

3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide,

N,N′-bis(salicyloyl)oxalyl dihydrazide,

N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite,

tris(2,4-di-tert-butylphenyl) phosphite, diisodecyl pentaerythritol diphosphite, bis(2,4-di-tert-butylphenyl) pentaerythritol diphosphite,

bis(2,6-di-tert-butyl-4-methylphenyl) pentaerythritol diphosphite, diisodecyloxy pentaerythritol diphosphite,

bis(2,4-di-tert-butyl-6-methylphenyl) pentaerythritol diphosphite, bis(2,4,6-tris(tert-butyl)phenyl) pentaerythritol diphosphite, tristearyl sorbitol triphosphite,

tetrakis(2,4-di-tert-butylphenyl) 4,4′-biphenylenediphosphonite,

6-isooctyloxy-2,4,8,10-tetra-tert-butyl-12H-dibenzo[d,g]-1,3,2-di oxaphosphocin, bis(2,4-di-tert-butyl-6-methylphenyl) methyl phosphite, bis(2,4-di-tert-butyl-6-methylphenyl) ethyl phosphite,

6-fluoro-2,4,8,10-tetra-tert-butyl-12-methyl-dibenzo[d,g]-1,3,2-dioxaphosphocin, 2,2′,2″-nitrilo[triethyl tris(3,3′,5,5′-tetra-tert-butyl-1,1′-biphenyl-2,2′-diyl) phosphite], 2-ethylhexyl

(3,3′,5,5′-tetra-tert-butyl-1,1′-biphenyl-2,2′-diyl) phosphite,

5-butyl-5-ethyl-2-(2,4,6-tri-tert-butylphenoxy)-1,3,2-dioxa-phosphirane.

5. Hydroxylamines, examples being N,N-dibenzylhydroxylamine,

N,N-diethylhydroxylamine, N,N-dioctylhydroxylamine,

N,N-dilaurylhydroxylamine, N,N-ditetradecylhydroxylamine,

N,N-dihexadecylhydroxylamine, N,N-dioctadecylhydroxylamine,

N-hexadecyl-N-octadecylhydroxylamine,

N-heptadecyl-N-octadecylhydroxylamine, N,N-dialkylhydroxylamine prepared from hydrogenated tallow fatty amine.

6. Nitrones, examples being N-benzyl α-phenyl nitrone, N-ethyl α-methyl nitrone, N-octyl α-heptyl nitrone, N-lauryl α-undecyl nitrone, N-tetradecyl α-tridecyl nitrone, N-hexadecyl α-pentadecyl nitrone, N-octadecyl α-heptadecyl nitrone, N-hexadecyl α-heptadecyl nitrone, N-octadecyl α-pentadecyl nitrone, N-heptadecyl α-heptadecyl nitrone, N-octadecyl α-hexadecyl nitrone, nitrone derived from N,N-dialkylhydroxylamine prepared from hydrogenated tallow fatty amine.

7. Thiosynergists, examples being dilaurylthiodipropionate and distearylthiodipropionate.

8. Peroxide scavengers, examples being esters of

3-thiodipropionic acid, for example the lauryl, stearyl, myristyl or tridecyl ester, mercaptobenzimidazole, or the zinc salt of

2-mercaptobenzimidazole, zinc dibutyldithiocarbamate, dioctadecyl disulfide, pentaerythritol tetrakis(β-dodecylmercapto)propionate.

9. Polyamide stabilizers, examples being copper salts in combination with iodides and/or phosphorus compounds and salts of divalent manganese.

10. Basic costabilizers, examples being melamine, polyvinylpyrrolidone, dicyandiamide, triallyl cyanurate, urea derivatives, hydrazine derivatives, amines, polyamines, polyurethanes, alkali metal and alkaline earth metal salts of higher fatty acids, for example Ca stearate, Zn stearate, Mg behenate, Mg stearate, Na ricinoleate and K palmitate, antimony pyrocatecholate or zinc pyrocatecholate.

11. Nucleating agents, such as inorganic substances, examples being talc, metal oxides, such as titanium dioxide or magnesium oxide, phosphates, carbonates or sulfates, preferably of alkaline earth metals; organic compounds, such as mono- or polycarboxylic acids and also their salts, examples being 4-tert-butylbenzoic acid, adipic acid, diphenylacetic acid, sodium succinate or sodium benzoate, polymeric compounds, such as ionic copolymers (ionomers). Particular preference is given to

1,3;2,4-bis(3′,4′-dimethylbenzylidene)sorbitol,

1,3;2,4-di(para-methyldibenzylidene)sorbitol, and

1,3;2,4-di(benzylidene)sorbitol.

12. Fillers and reinforcing agents, examples being calcium carbonate, silicates, glass fibers, hollow glass microbeads, asbestos, talc, kaolin, mica, barium sulfate, metal oxides and metal hydroxides, carbon black, graphite, wood flour and other flours or fibers of other natural products, synthetic fibers.

13. Other additives, examples being plasticizers, lubricants, emulsifiers, pigments, rheological additives, catalysts, leveling assistants, optical brighteners, flameproofing agents, antistatics, blowing agents.

14. Benzofuranones and indolinones, such as those described in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-43 16 611; DE-A-43 16 622; DE-A-43 16 876; EP-A-0 589 839 or EP-A-0 591 102 or

3-[4-(2-acetoxyethoxy)phenyl]-5,7-di-tert-butyl-benzofuran-2-one,

5,7-di-tert-butyl-3-[4-(2-stearoyloxyethoxy)phenyl]benzofuran-2-one,

3,3′-bis[5,7-di-tert-butyl-3-(4-[2-hydroxyethoxy]phenyl)benzo-furan-2-one],

5,7-di-tert-butyl-3-(4-ethoxyphenyl)benzofuran-2-one,

3-(4-acetoxy-3,5-dimethylphenyl)-5,7-di-tert-butylbenzofuran-2-one,

3-(3,5-dimethyl-4-pivaloyloxyphenyl)-5,7-di-tert-butylbenzofuran-2-one,

3-(3,4-dimethylphenyl)-5,7-di-tert-butylbenzofuran-2-one,

3-(2,3-dimethylphenyl)-5,7-di-tert-butyl-benzofuran-2-one.

The ratio by weight of the other additives C) to the stabilizers B) may be from 100:1 to 1:100, for example.

The amounts used of the other additives C) mentioned are the usual amounts, in particular from 0.001 to 50% by weight, based on the stabilized thermoplastic composition.

In the process of the invention, the stabilizers B) and, if present, the other components C) are added to the polyolefin in the usual manner. For example, the stabilizers B) and, where appropriate, the other additives C) may be added to the starting monomers (olefin monomers), and the mixture of monomers and stabilizers may be polymerized. The stabilizers may also be added during the polymerization of the olefin monomers. A prerequisite for addition prior to or during the polymerization is that the stabilizers are stable under the polymerization conditions, i.e. undergo no, or only little, decomposition.

It is preferable for the stabilizers B) and, if present, the other components C) to be added to the finished polyolefin A). This takes place in the usual manner using mixing processes known per se, for example with melting in a mixer from 150 to 300° C.

However, the components may also be mixed “cold”, without melting, and the mixture composed of pellets or of powder melted and homogenized only once processing has begun.

The manner of adding the stabilizers B) and the components C) may, of course, be that they are added together or separately from one another, all at once, in portions, or continuously, at constant rate or following a gradient. For example, one portion of the stabilizer may be added before the polymerization of the olefin monomers is complete, and the remainder added to the finished polyolefin.

Examples of mixers for carrying out the process of the invention are heated batchwise-operated internal mixers with or without ram, continuous kneaders, e.g. continuous internal mixers, screw kneaders with axial oscillating screws, Banbury mixers, and extruders, and also roll mills, heated mixing rolls, and calenders.

Blending preferably takes place in a conventional extruder, by introducing the components mixed or individually, for example entirely via a hopper into the extruder, or else some portion of the same may be introduced at a downstream point along the extruder into the molten or solid product present within the extruder. Examples of equipment particularly suitable for melt extrusion are single- and twin-screw extruders. A twin-screw extruder is preferred.

The resultant mixtures may be pelletized or granulated, for example, or processed by well known processes, such as extrusion, injection molding, foaming with blowing agents, thermoforming, blow molding, or calendering.

The molding compositions may be used to produce moldings (including semifinished products, sheeting, fibers, films, and foams) of any type, such as items for everyday use, packaging, sheeting, moldings for any external use, e.g. garden furniture, windows and accessories, lamp housings, exterior parts for motor vehicles. The moldings, films, and fibers are provided by the invention.

The molding compositions of the invention have an ideal and balanced property profile. This likewise applies to the moldings, fibers, and films produced from the same.

Finally, mention may be made of a point of interest in the context of plastics processing.

It is known that polyolefins which have been prepared using metallocene catalysis usually have a narrow molecular weight distribution—the proportion of short-chain polymers being markedly less than in polyolefins prepared by means of Ziegler-Natta catalysts. The processing aids traditionally used, e.g. waxes, metal stearates, and fatty acid derivatives which have been or still are added during plastics processing, e.g. to prevent melt fracture (visible as surfaces with a rough or scaly structure) therefore reach their performance limits and are increasingly replaced by more effective auxiliaries, especially fluoroelastomers and silicones.

With regard to the mode of action of fluoroelastomers, for example, the assumption is that these have no or very little miscibility with the polyolefins and therefore migrate to the surface of the polymer melt while still within the processing equipment, e.g. an extruder, where they form a lubricating layer between the melt and the surface of the processing equipment. This suppresses adhesion, one of the results of which can be melt fracture.

In the applicant's extrusion trials using polyolefins which had been treated with various commercially available light stabilizers it was found that in most cases—unlike with the unstabilized polyolefin—it was necessary to add markedly higher amounts of fluoroelastomer to prevent melt fracture or there was occurrence of melt fracture when usual amounts of the elastomers were used: about 0.1% by weight, based on the polymer. This adverse effect was comparatively small when using the product Tinuvin 622 (Ciba), but in the case of Uvinul® 5050H a marked further reduction was possible. The amount of fluoroelastomer could therefore be markedly reduced below the usual concentration without melt fracture of the polyolefin with Uvinul® 5050H additive.

We claim:

1. A stabilized thermoplastic molding composition comprising
A) at least one polyolefin A) prepared using at least one metallocene catalyst, and
B) at least one stabilizer B) selected from the following groups. b1) to b4)
b1) sterically hindered amines based on glycolurils,
b2) sterically hindered amines based on 4-formylaminopiperidines,
b3) sterically hindered amines based on maleimide-α-olefin copolymers,
b4) sterically hindered amines based on
bis(2,2,6,6-tetramethylpiperidin-4-yl) sebacate,
bis(2,2,6,6-tetramethylpiperidin-4-yl) succinate,
bis(1,2,2,6,6-pentamethylpiperidin-4-yl) sebacate,
bis(1-octyloxy-2,2,6,6-tetramethylpiperidin-4-yl)
sebacate, bis(1,2,2,6,6-pentamethylpiperidin-4-yl)
n-butyl-3,5-di-tert-butyl-4-hydroxybenzylmalonate, the condensation product of
1-(2-hydroxyethyl)-2,2,6,6-tetramethyl-4-hydroxypiperidine and succinic acid, the condensation product of N,N′-bis(2,2,6,6-tetramethylpiperidin-4-yl)hexamethylenediamine and 4-tert-octylamino-2,6-dichloro-1,3,5-triazine,
tris(2,2,6,6-tetramethylpiperidin-4-yl) nitrilotriacetate,
tetrakis(2,2,6,6-tetramethylpiperidin-4-yl) butane
1,2,3,4-tetracarboxylate,
1,1′-(1,2-ethylene)bis(3,3,5,5-tetramethyl-piperazinone), 4-benzoyl-2,2,6,6-tetramethylpiperidine, 4-stearyloxy-2,2,6,6-tetramethylpiperidine, bis(1,2,2,6,6-pentamethylpiperidin-4-yl)
2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione,
bis(1-octyloxy-2,2,6,6-tetramethylpiperidin-4-yl) sebacate,
bis(1-octyloxy-2,2,6,6-tetramethylpiperidin-4-yl) succinate, the condensation product of
N,N′-bis(2,2,6,6-tetramethylpiperidin-4-yl)hexamethylenediamine and 4-morpholino-2,6-dichloro-1,3,5-triazine, the condensation product of
2-chloro-4,6-bis(4-n-butylamino-2,2,6,6-tetramethylpiperidin-4-yl)-1,3,5-triazine and 1,2-bis(3-aminopropylamino)ethane, the condensation product of 2-chloro-4,6-di(4-n-butylamino-1,2,2,6,6-pentamethyl-piperidin-4-yl)-1,3,5-triazine and 1,2-bis-(3-amino-propylamino)ethane,
8-acetyl-3-dodecyl-7,7,9,9-tetra-methyl-1,3,8-triazaspiro[4.5]decane-2,4-dione,
3-dodecyl-1-(2,2,6,6-tetramethylpiperidin-4-yl)pyrrolidine-2,5-dione,
3-dodecyl-1-(1,2,2,6,6-pentamethylpiperidin-4-yl)pyrrolidine-2,5-dione, a mixture of
4-hexadecyloxy- and 4-stearyloxy-2,2,6,6-tetramethylpiperidine, the condensation product of
N,N′-bis(2,2,6,6-tetramethylpiperidin-4-yl)hexamethylenediamine and 4-cyclohexylamino-2,6-dichloro-1,3,5-triazine, the condensation product of
1,2-bis(3-aminopropylamino)ethane and 2,4,6-trichloro-1,3,5-triazine,
4-butylamino-2,2,6,6-tetramethylpiperidine,
N-(2,2,6,6-tetramethylpiperidin-4-yl)-n-dodecylsuccinimide,
N-(1,2,2,6,6-pentamethylpiperidin-4-yl)-n-dodecylsuccinimide,
2-undecyl-7,7,9,9-tetramethyl-1-oxa-3,8-diaza-4-oxo-spiro[4.5]decane, the condensation product of
7,7,9,9-tetramethyl-2-cycloundecyl-1-oxa-3,8-diaza-4-oxospiro-[4.5]decane and epichlorohydrin, the condensation products of
4-amino-2,2,6,6-tetramethylpiperidine with tetramethylolacetylenediureas and poly(methoxypropyl-3-oxy)[4-(2,2,6,6-tetramethyl)piperidinyl]siloxane.

2. A molding composition as claimed in claim 1, in which the total amount of the stabilizers is from 0.001 to 10% by weight, based on the stabilized thermoplastic molding composition.

3. A molding composition as claimed in claim 1 or 2, in which the amine b1) used and based on glycolurils is an amine of the formula 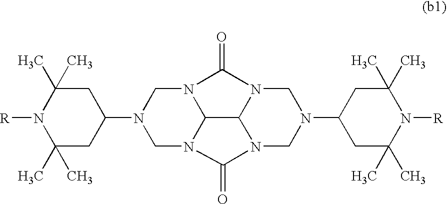
where R is hydrogen or methyl.

4. A molding composition as claimed in any of claims 1 to 3, in which the amine b2) used and based on 4-formylaminopiperidines is an amine of the formula 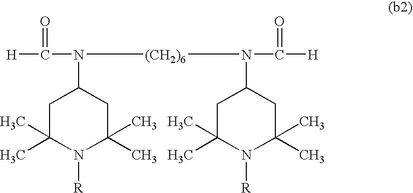
where R is hydrogen or methyl.

5. A molding composition as claimed in any of claims 1 to 4, in which the amine b3) used and based on maleimide-α-olefin copolymers is an amine of the formula 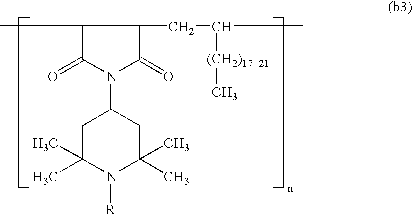
where R is hydrogen or methyl, n being selected such that the molecular weight is about 3500.

6. A molding composition as claimed in any of claims 1 to 5, which comprises a component C) selected from the group consisting of polymers other than the polyolefins A) and of additives other than the stabilizers B).

7. The use of the molding compositions as claimed in any of claims 1 to 6 for producing moldings, films, or fibers.

8. A molding, film, or fiber made from the molding compositions as claimed in any of claims 1 to 6.

9. A process for preparing the molding compositions as claimed in any of claims 1 to 6, which comprises mixing the components A), B), and, where appropriate, C) at from 150 to 300° C. in a mixer, with melting.
